(19) United States
(12) Patent Application Publication
(10) Pub. No.: US 2010/0258627 A1
(43) Pub. Date: Oct. 14, 2010

(54) CONFIGURATION INFORMATION COMPLEMENTING TRACEABILITY SYSTEM

(75) Inventors: Michiki NAKANO, Tokyo (JP); Yohei KAWADA, Sagamihara (JP); Suenori ODA, Yokohama (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/692,148

(22) Filed: Jan. 22, 2010

(30) Foreign Application Priority Data
Apr. 9, 2009 (JP) 2009-094503

(51) Int. Cl. G06Q 30/00

(52) U.S. Cl. 235/385

(57) ABSTRACT

In traceability system applications, it is required to check relationships between individual articles under management and containers therefor such as container cases or pallets. Since relevant data in each stage of physical distribution is not always registered, the absence of some necessary data may occur to cause inaccurate commodity tracing. To solve this disadvantage, the present invention provides a traceability system capable of complementing information regardless of time-series factors. Even in a situation where a plurality of sets of information (relational data) regarding packing-unpacking relationships between articles and containers, e.g., relationships between commodity products and packing cases, or relationships between packing cases and pallets, are not registered in time-series order, the relational data are complemented in registration to enable complementary estimation from registered information available at the time of reference.

### BACKGROUND OF THE INVENTION

The present invention relates to a traceability system for keeping track of physical distribution states of commodity items/products (individual articles), and more particularly to a technique for complementing packing-unpacking configuration information with data that is likely to be absent in conventional detection or input operation arrangements for traceability system implementation.

In Japanese Patent Application Laid-Open Publication No. 2008-13262 indicated below, there is disclosed a traceability system for keeping track of physical distribution states of commodity items/products for management thereof.

The following conditions regarding traceability system applications are described in Japanese Patent Application Laid-Open Publication No. 2008-13262. As a predefinition, the meaning of “traceability” is explained as follows. “Traceability” means a functional feature that enables commodity tracing in physical distribution, i.e., a functional capability that allows post-checking of history records, destinations, locations, packing configurations/contents, change/alteration records, and other distribution conditions of commodity items/products on a unit-of-management basis. It is required for a traceability system to meet the following two basic requirements; the one requirement is a “tracing-forward” function for enabling identification of individual commodity items/products on an accurate unit-of-management basis with the progress of distribution thereof, and the other requirement is a “tracing-back” function for enabling retrospective retrieval of record data of individual commodity items/products after the progress of distribution thereof through some processes.

In a traceability system as mentioned above, information registration and management are carried out with respect to date-time records and source-route records of object commodity items/products, and packing configurations of the object commodity items/products in each distribution process.

In Japanese Patent Application Laid-Open Publication No. 2008-13262, the following problem with distribution of packed commodity items/products is pointed out. In conventional traceability system applications, predetermined objects only, such as commodity items/products themselves, are traced forward without management or checkup of information including packing conditions in each distribution process. Therefore, in each distribution process, although it is allowed to check when commodity items/products have passed a certain distribution point, there arises a problem that tracing-forward and tracing-back of packing conditions in the course of distribution cannot be carried out.

According to Japanese Patent Application Laid-Open Publication No. 2008-13262, the following arrangement for a traceability system is proposed in an attempt to enable tracing-forward and tracing-back of commodity items/products and packing conditions thereof in each distribution process. In the arrangement described in Japanese Patent Application Laid-Open Publication No. 2008-13262, there are provided trace object master data and trace object container contents map data. In the trace object master data, each commodity item/product is associated with date and time information of departure and arrival thereof, and each container (container case) is also associated with date and time information of departure and arrival thereof for management in distribution. In the trace object container contents map data, each commodity item/product is associated with a container used in packing process thereof so as to set up a correspondence relationship between each commodity item/product and a container therefor.

### SUMMARY OF THE INVENTION

It is to be noted, however, that the traceability system proposed in Japanese Patent Application Laid-Open Publication No. 2008-13262 is arranged on the precondition that packing information and unpacking information of commodity items/products should be registered in time-series order. Referring to FIG. 2, there is shown an exemplary situation in which product 00, product 01, product 02, and product 03 are packed into container case aa at distribution site A at clock time 1:00, product 01 is unpacked from container case aa at distribution site B at clock time 2:00, product 01 is packed again into container case bb at distribution site C at clock time 3:00, and then, at distribution site D, all the products are unpacked from container case aa at time clock 4:00, and product 01 is unpacked from container case bb at time clock 5:00. In this situation, for checking the contents of each container case or pallet by searching for relevant relational data stored in the traceability system at the time of arrival to each distribution site or departure therefrom, it is required to register packing information and unpacking information of commodity items/products and container cases into the traceability system in the time-series order indicated above. However, in a case where data of different distribution sites are managed at one location, time-series registration of packing information and unpacking information from each distribution site is not ensured due to variations in timing of information transmission or any other cause. For example, where packing information and unpacking information are not registered in time-series order, i.e., packing information and unpacking information are registered periodically on a batch-processing basis, there arises a disadvantage that packing information and unpacking information may not be registered in time-series order due to variations in timing of batch processing registration among distribution sites. Under the condition that packing information of product 00, product 01, product 02, product 03, and container case aa at distribution site A, and packing information of product 01 and container case bb at distribution site C are registered exclusively, a search at distribution site D for relational data of container cases aa and bb causes the occurrence of erroneous configuration information indicating that product 01 is contained in both the container cases aa and bb. Further, where configuration information of container cases or pallets at the current point of time is required for acceptance inspection, delivery inspection, or the like, a processing time length required to search for relevant relational data should be shortened to increase the efficiency of transaction for physical distribution. However, as in conventional traceability systems, if relational data including packing and unpacking information are held in a single data table or database, a longer search processing time is required disadvantageously with an increase in the amount of packing and unpacking information.

In the light of the above, it is an object of the present invention to provide a traceability system wherein, even if relational data including packing and unpacking information of commodity items/products are not registered in time-series order, it is allowed to furnish configuration information to be estimated from registered relational data available at the time of search. Further, it is another object of the present invention to provide a traceability system that can prevent an increase in search processing time required to search for relevant relational data even in cases where the amount of relational data increases.

In accomplishing these objects of the present invention and according to one aspect thereof, there is provided a traceability system wherein, even if a plurality of sets of information (relational data) regarding packing-unpacking relationships between articles and containers, e.g., relationships between commodity items/products and packing cases, or relationships between packing cases and pallets, are not registered in time-series order, the relational data are complemented in registration to enable complementary estimation from registered information available at the time of reference. More specifically, the following arrangements are provided according to the present invention.

In the present invention, complementary registration of relational data including packing and unpacking information is performed in cases where the relational data are not registered in time-series order. Further, according to the present invention, at the time of storing relational data for management, correspondence relationships are set up with respect to article identification information for identifying each article (commodity item/product), container identification information for identifying each container for containing the article, date-and-time information indicating the start of relation due to packing, and date-and-time information indicating the end of relation due to unpacking. In addition, correspondence relationships are also set up regarding whether the date-and-time information indicating the start/end of relation has been complemented or entered as actual input record data (relational data are stored with association linkage regarding complementation/actual input record for management).

Furthermore, according to the present invention, there is provided a specific storage region dedicated for storing complemented relational data only in addition to a storage region for storing other relational data. Thus, when the latest configuration information is required, a search is performed in the specific storage region dedicated for storing complemented relational data only, thereby making it possible to prevent an increase in search processing time.

Still further, the following aspects are also included in the present invention. In a configuration information complementing traceability system for complementing configuration information indicating states of physical distribution of individual articles (commodity products/items) according to the present invention, there are provided an input acceptance section for accepting article identification information for identifying each article in a predetermined stage of the physical distribution, container identification information for identifying each container for containing the article, and relational data indicating a corresponding relationship including temporal element information regarding the article identification information and the container identification information; a storage section for storing the article identification information and the container identification information accepted by the input acceptance section as configuration information associated with the relational data; and a complementer section for judging whether any necessary data is absent in the configuration information to be stored in accordance with the relational data, and for complementing the configuration information by using the relational data if the absence of any necessary data is recognized in the result of judgment on the configuration information. It is to be noted that the relational data includes temporal element information indicating the start and end of a correspondence relationship (packing-unpacking relationship) between each article and a container therefor, i.e., temporal element information regarding continuance (or discontinuance) of each correspondence relationship therebetween. Still further, the present invention includes each device arranged for forming the configuration information complementing traceability system mentioned above, each computer program to be run for device operation, and each method for using the configuration information complementing traceability system and each device arranged for forming the same. Still further, the present invention also includes combinations of devices and methods according to respective aspects thereof.

As described above and according to the present invention, it is possible to realize a traceability system capable of providing configuration information to be estimated from registered contents available at the time of search even in cases where relational data including packing and unpacking information of articles (commodity items/products) are not registered in time-series order.

### BRIEF DESCRIPTION OF THE DRAWINGS

Embodiments of the present invention will be described in detail based on the following figures, wherein:

FIG. 1 is a schematic diagram showing an exemplary arrangement of a configuration information complementing traceability system according to a preferred embodiment of the present invention;

FIG. 2 is an explanatory diagram showing alterations in packing-unpacking relationship between commodity items/products and container cases thereof;

FIG. 3 is a tabular diagram showing exemplary relational data according to the preferred embodiment of the present invention;

FIG. 4 is a tabular diagram showing exemplary end-of-relation data according to the preferred embodiment of the present invention;

FIG. 5 is a tabular diagram showing exemplary referencer data regarding complementary relational data according to the preferred embodiment of the present invention;

FIG. 6 is a flowchart showing a general flow of data processing steps at respective processing sections of a PC according to the preferred embodiment of the present invention;

FIG. 7 is a flowchart showing a general flow of data processing steps at respective processing sections in a traceability data center according to the preferred embodiment of the present invention;

FIG. 8 is a flowchart showing details of data processing in step S3 according to the preferred embodiment of the present invention;

FIG. 9 is a flowchart showing details of data processing in step S5 according to the preferred embodiment of the present invention;

FIG. 10 is a flowchart showing details of data processing in step S52 according to the preferred embodiment of the present invention;

FIG. 11 is a flowchart showing details of complementary processing of relational data associated with end-of-relation omission data in step S523 according to the preferred embodiment of the present invention;

FIG. 12 is a flowchart showing details of complementary processing of relational data associated with end-of-relation omission data in step S524 according to the preferred embodiment of the present invention;

FIG. 13 is a flowchart showing details of data processing in step S53 according to the preferred embodiment of the present invention;

FIG. 14 is a flowchart showing details of complementary registration processing “c” in step S534 according to the preferred embodiment of the present invention;

FIG. 15 is a flowchart showing details of complementary registration processing “f” in step S5347 according to the preferred embodiment of the present invention;

FIG. 16 is a flowchart showing details of complementary registration processing “g” in step S5348 according to the preferred embodiment of the present invention;

FIG. 17 is a flowchart showing details of complementary registration processing “h” in step S5349 according to the preferred embodiment of the present invention;

FIG. 18 is a flowchart showing details of data processing in step S54 according to the preferred embodiment of the present invention;

FIG. 19 is a flowchart showing details of complementary registration processing “j” in step S544 according to the preferred embodiment of the present invention;

FIG. 20 is a flowchart showing details of complementary registration processing “m” in step S5443 according to the preferred embodiment of the present invention;

FIG. 21 is a flowchart showing details of complementary registration processing “n” in step S5447 according to the preferred embodiment of the present invention;

FIG. 22 is a flowchart showing details of data processing at a complementary relational data memory register section according to the preferred embodiment of the present invention;

FIG. 23 is a flowchart showing details of data processing at a complementary relational data referencer management section according to the preferred embodiment of the present invention;

FIG. 24 shows an example of registration of start-of-relation data according to the preferred embodiment of the present invention;

FIG. 25 shows an example of registration of end-of-relation data according to the preferred embodiment of the present invention;

FIG. 26 shows an example of registration of end-of-relation omission data according to the preferred embodiment of the present invention;

FIG. 27 shows an example of registration of end-of-relation data complemented with starting time information thereof according to the preferred embodiment of the present invention; and

FIG. 28 shows another example of registration of end-of-relation data complemented with starting time information thereof according to the preferred embodiment of the present invention.

### DETAILED DESCRIPTION OF THE PREFERRED EMBODIMENTS

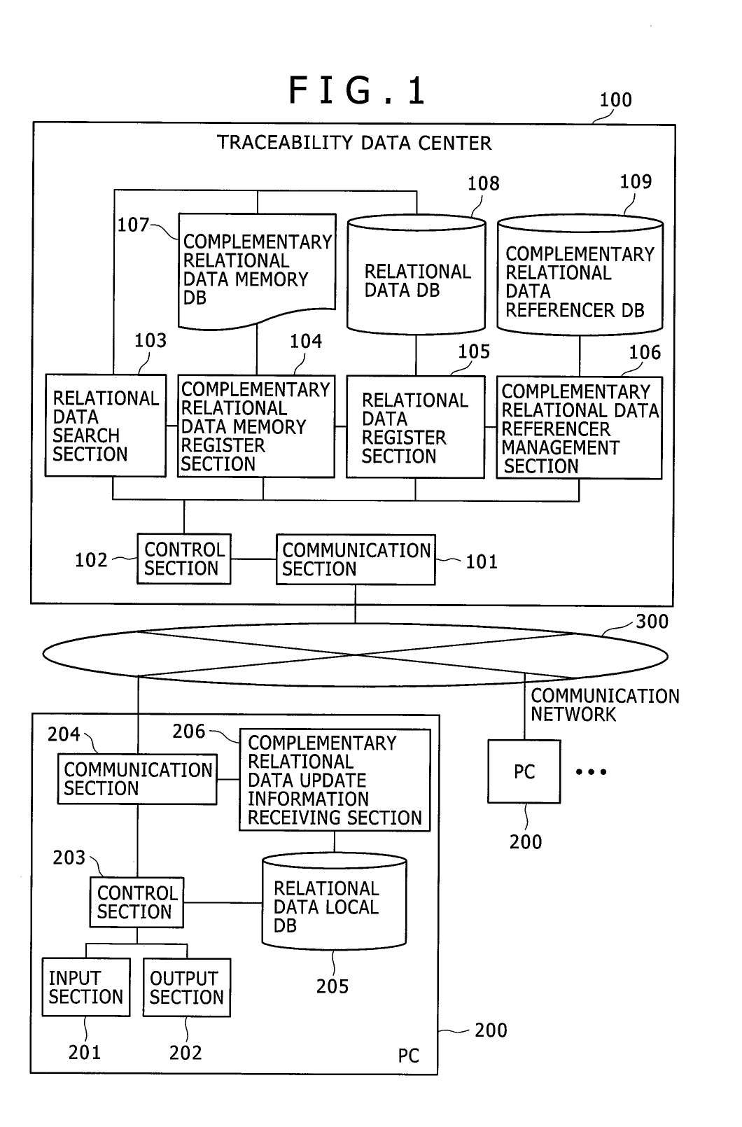

The present invention will now be described in detail by way of example with reference to the accompanying drawings. Referring to FIG. 1, there is shown an exemplary arrangement of a configuration information complementing traceability system according a preferred embodiment of the present invention. The configuration information complementing traceability system includes a traceability data center 100, a personal computer (PC) 200 installed at each distribution site, and a communication network 300 such as a telephone line network, local area network (LAN) or dedicated line network.

The PC 200 is used for management of commodity items/products to be packed in container cases or unpacked therefrom or to be loaded to pallets or unloaded therefrom. The PC 200 includes a communication section 204 including such devices as a modem, router, and terminal adapter, an input section 201 including such input devices as a mouse and keyboard, an output section 202 including such output devices as a display and printer, a control section 203, a complementary relational data update information receiving section 206, and a relational data local DB 205. The term “relational data” as used herein refers to data indicating when commodity items/products were packed into container cases or loaded to pallets and when the commodity items/products were unpacked from the container cases or unloaded from the pallets. Included in the relational data are article identification information of commodity items/products to be packed, container identification information of container cases for packing the commodity items/products or pallets for loading the commodity items/products, start-of-relation time information due to packing into container cases or loading to pallets, and end-of-relation time information due to unpacking from the container cases or unloading from the pallets. The relational data local DB 205 is retained in a storage device such as a hard disk, for example. The term “complementary relational data” as used herein refers to relational data in which either a start-of-relation time or an end-of-relation time is indicated in accordance with time information complemented with other relational data information, not based on actual input time information. The control section 203 can be implemented by using a so-called CPU where calculations are carried out under program control.

The input section 201 is provided with a display screen or communication interface for allowing a user to enter information. Through the input section 201, information input by the user is obtained, and the input information thus obtained is fed to the control section 203. In addition to a mouse and keyboard, the input section 201 may further include such input devices as a two-dimensional or three-dimensional barcode reader, IC tag reader, interface device, mobile phone device, and IC reading device, for example. With these input devices, the user may enter information as required. It is to be noted, however, that the present invention is not limited to these input devices and that information may be entered by using any other kind of input device.

The output section 202 obtains information output from the control section 203, and provides the information thus obtained to the user through a display screen or communication interface.

The control section 203 acquires input information from the input section 201, and branchingly furnishes the input information thus acquired to either of the communication section 204 and the relational data local DB 205 in accordance with the kind of the input information and conditions specified therefor. Further, the control section 203 acquires information from the communication section 204 and the relational data local DB 205, registers relevant information into the relational data local DB 205 in accordance with conditions specified therefor, and furnishes output information to the output section 202.

The complementary relational data update information receiving section 206 receives update information regarding relational data in the traceability data center 100 through the communication section 204. In accordance with the contents of the update information thus received, the contents of the relational data local DB 205 are updated as required.

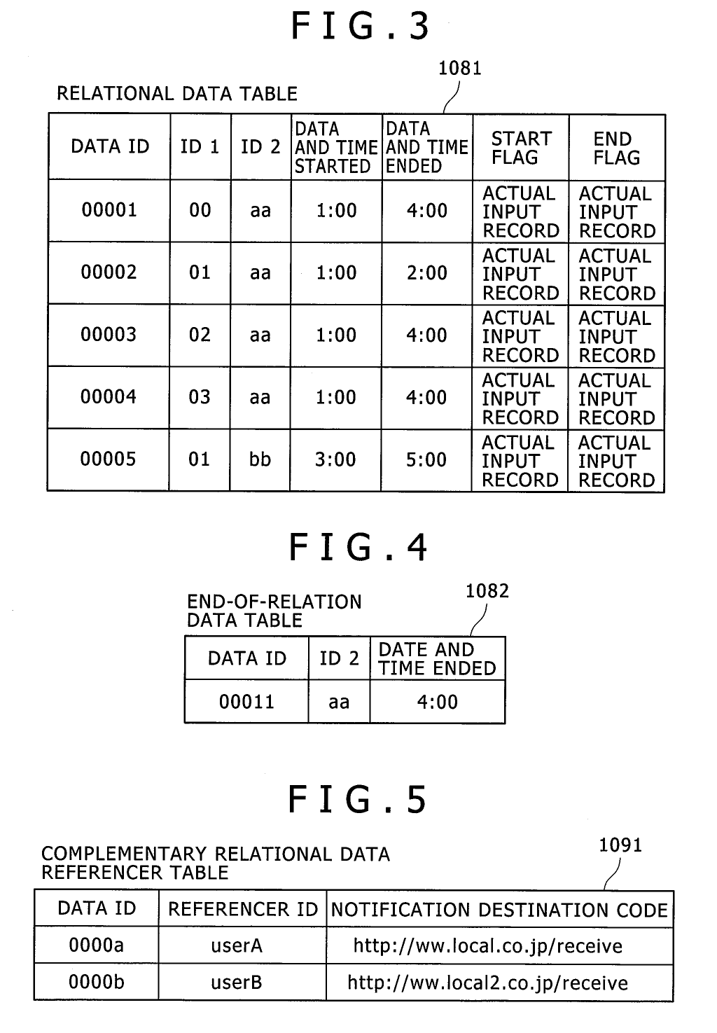

The relational data local DB 205 is used for retaining information received from the traceability data center 100 at the time of referencing relational data therein. Data tables having a structure similar to that of a relational data table 1081 shown in FIG. 3 are included in the relational data local DB 205. The relational data table 1081 will be described in detail later.

The traceability data center 100 collects relational data regarding commodity items/products from the PC 200 installed at each distribution site and manages the relational data thus collected. Implemented as a so-called server, the traceability data center 100 has a communication section 101 including such devices as a modem, router, and terminal adapter, a control section 102, a relational data search section 103, a complementary relational data memory register section 104, a relational data register section 105, a complementary relational data referencer management section 106, a complementary relational data memory DB 107, a relational data DB 108, and a complementary relational data referencer DB 109. The complementary relational data memory DB 107 is retained in a semiconductor memory device such as a RAM device, for example. The relational data DB 108 and the complementary relational data referencer DB 109 are retained in a storage device such as a hard disk, for example.

The communication section 101 receives input information through the communication network 300, and feeds the input information thus received to the control section 102. Further, the communication section 101 obtains output information from the control section 102, and sends the output information thus obtained to the PC 300 at each distribution site in accordance with the kind of the output information and conditions specified therefor.

Upon acquisition of input information from the communication section 101, the control section 102 branchingly furnishes the input information to any of the relational data search section 103, the complementary relational data memory register section 104, the relational data register section 105, and the complementary relational data referencer management section 106 in accordance with the kind of the input information and conditions specified therefor. Further, the control section 102 acquires information from the relational data search section 103, the complementary relational data memory register section 104, the relational data register section 105, and the complementary relational data referencer management section 106, and furnishes output information to the communication section 101. As is the case with the control section 203, the control section 102 can be implemented by using a so-called CPU where calculations are carried out under program control. Other sections or devices that perform calculations can also be implemented in a similar fashion.

The relational data search section 103 acquires search conditions for relational data and referencer identification information (ID) from the control section 102. The search conditions for relational data include an identification number of an object item, clock time, and search direction. In acquisition of configuration information on an object item, a search direction is used as a specifier for selection between configuration information indicating what is contained in the object item and configuration information indicating in what the object item is contained. After acquiring search conditions for relational data, the relational data search section 103 performs a search for relational data in the complementary relational data memory DB 107 and the relational data DB 108 in accordance with the search conditions acquired.

The complementary relational data memory register section 104 acquires information regarding relational data from the relational data register section 105, and accesses the complementary relational data memory DB 107 to perform registration, updating, or deregistration as required.

The relational data register section 105 acquires relational data from the control section 102, and accesses the relational data DB 108 to perform registration or updating. In this operation, the relational data register section 105 searches the relational data DB 108 to check whether or not the relational data acquired from the control section 102 meets the time-series condition concerned. If it is judged that the acquired relational data does not meet the time-series condition concerned, the relational data register section 105 complements the acquired relational data with start-of-relation or end-of-relation time information, and registers the relational data thus complemented. To be more specific, if the acquired relational data is found to be data indicating the start of relation (hereinafter referred to as start-of-relation data) such as packing information, the acquired relational data is complemented with end-of-relation time information. Alternatively, if the acquired relational data is found to be data indicating the end of relation (hereinafter referred to as end-of-relation data) such as unpacking information, the acquired relational data is complemented with start-of-relation time information. In registration or updating, the relational data thus complemented is fed to the complementary relational data memory register section 104 and the complementary relational data referencer management section 106. Upon completion of registration processing, the result of the processing is returned to the control section 102.

The complementary relational data referencer management section 106 acquires information regarding a complementary relational data memory DB referencer from the relational data search section 103, and accesses the complementary relational data referencer DB 109 to register relevant information. Further, from the relational data register section 105, the complementary relational data referencer management section 106 acquires information regarding registered/updated relational data, and accesses the complementary relational data referencer DB 109 according to the information thus acquired. An identification code and a notification destination code of a user specified as a referencer to the relational data acquired from the relational data register section 105 are extracted from the complementary relational data referencer DB 109, and the result of the extraction is returned to the control section 102.

The relational data DB 108 serves as a database for storing relational data registered by the relational data register section 105, i.e., identification information of an object item related to packing or the like, a clock time indicating the start of relation due to packing or the like, a clock time indicating the end of relation due to unpacking or the like, and information regarding complementation/actual input record with respect to time information. As examples of data tables included in the relational data DB 108, FIG. 3 shows a relational data table 1081, and FIG. 4 shows an end-of-relation table 1082. The relational data table 1081 includes the following entry elements; “Data ID”, “ID1”, “ID2”, “Date and time started”, “Date and time ended”, “Start flag”, and “End flag”. The element “Data ID” is identification information that is uniquely provided to represent each relational data. The element “ID1” indicates identification information of an object item contained in commodity packing relation, and the element “ID2” indicates identification information of a container containing the object item in commodity packing relation. For example, in an instance where a product “0” is contained in a container case “a”, data “0” and data “a” are recorded in “ID1” and “ID2”, respectively. The element “Date and time started” indicates the date and time when the commodity packing relation concerned was initiated due to packing process, for example. The element “Date and time ended” indicates the date and time when the commodity packing relation concerned was ended due to unpacking process, for example. The elements “Start flag” and “End flag” indicate whether the “Date and time started” and “Date and time ended” are indicated as data complemented by the relational data register section 105 or as actual input record data (not complemented). The end-of-relation data table 1082 includes the following entry elements; “Data ID”, “ID2”, and “Date and time ended”. The element “Data ID” is identification information that is uniquely provided to represent each end-of-relation data. The element “ID2” indicates identification information of a container containing an object item in commodity packing relation.

In the end-of-relation data table 1082, end-of-relation omission data is registered. The end-of-relation omission data is generated when each commodity item/product is taken out of a container case or pallet. While having identification information of a container case or pallet and the date and time when all the commodity items/products are taken out of the container case or pallet, the end-of-relation omission data does not include identification information of each commodity item/product taken out of the container case or pallet.

The complementary relational data memory DB 107 serves as a database for storing relational data complemented by the relational data register section 105. More specifically, among information stored in the relational data DB 108, relational data complemented with start-of-relation time information due to packing or the like, relational data complemented with end-of-relation time information due to unpacking or the like, and relational data with nullified time information (e.g., relational data proper only) are stored in the complementary relational data memory DB 107. Data tables having a structure similar to that of the relational data table 1081 shown in FIG. 3 are contained in the complementary relational data memory DB 107.

The complementary relational data referencer DB 109 serves as a database for storing identification information of each user who has made reference to data held in the complementary relational data memory DB 107, and information regarding a destination for notification of data update information to the user. As an example of a data table included in the complementary relational data referencer DB 109, FIG. 5 shows a complementary data referencer table 1091. The complementary data referencer table 1091 includes the following entry elements; “Data ID”, “Referencer ID”, and “Notification destination code”. The element “Data ID” is identification information that is uniquely provided to represent each referencer data. The element “Referencer ID” indicates identification information assigned to each relational data referencer. The element “Notification destination code” indicates a referencer-specified destination for notification of data update information.

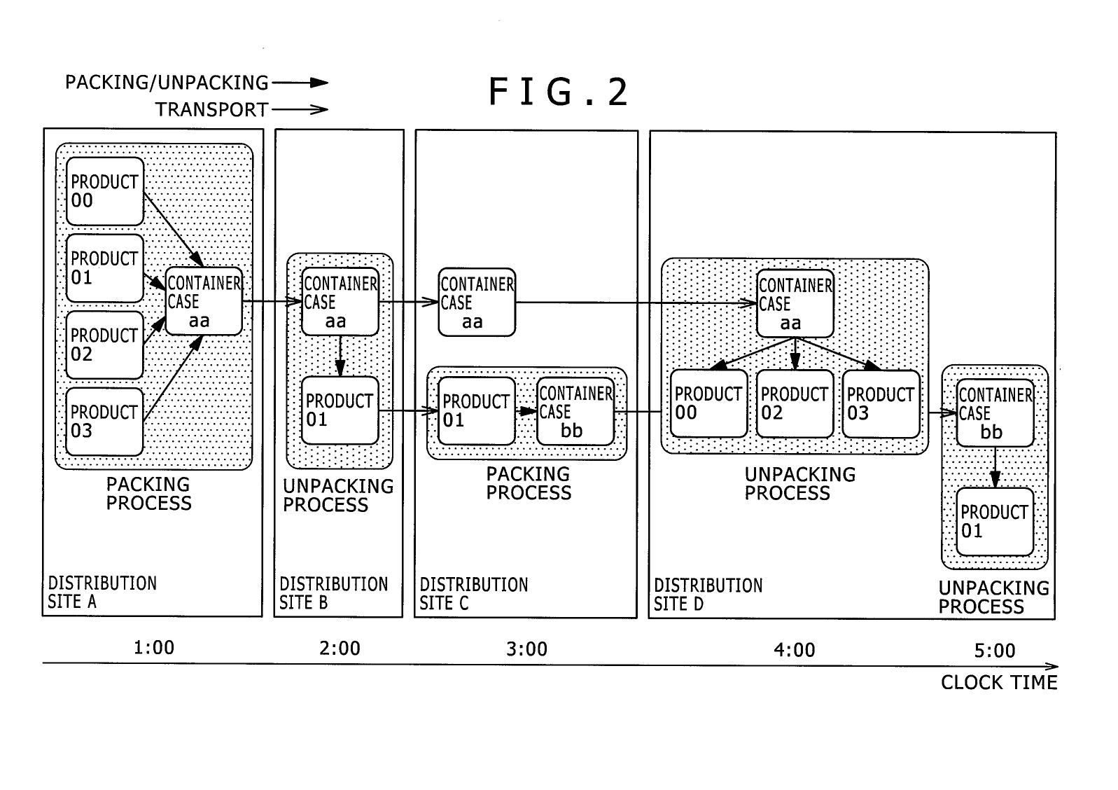

The data tables demonstrated in FIGS. 3, 4 and 5 show specific examples of data in an instance where relational data regarding packing-unpacking processes indicated in FIG. 2 are registered in time-series order.

The following describes in further detail the operations of the configuration information complementing traceability system arranged according to the preferred embodiment of the present invention.

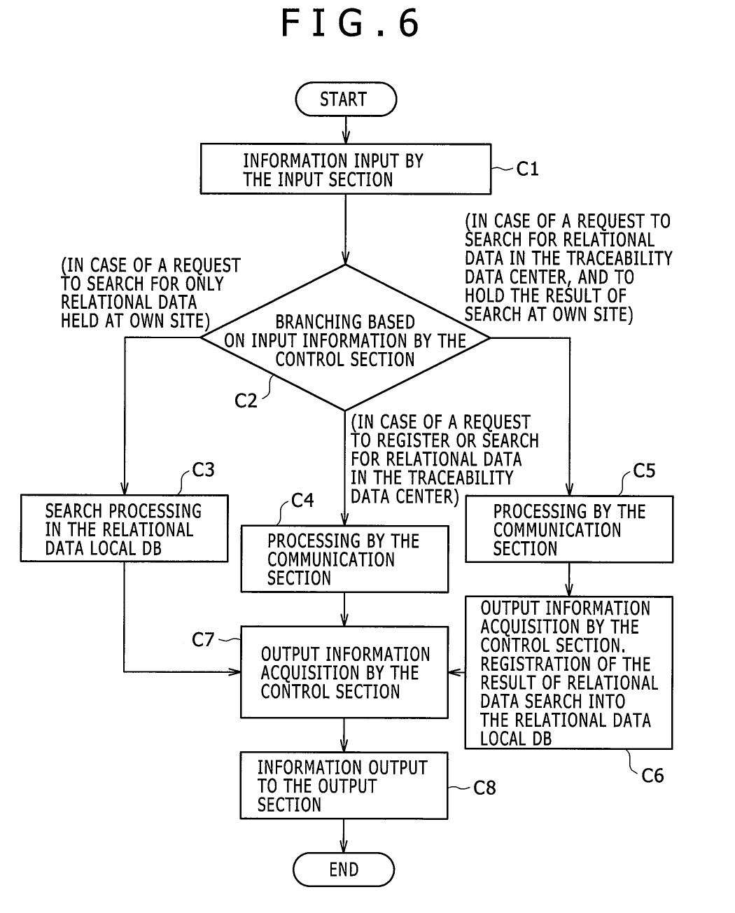

Referring to FIG. 6, there is shown a flowchart of data processing steps to be performed upon occurrence of a request for relational data search or registration through the input section 201 of the PC 200. First, the user enters input information to the input section 201 (C1). The input information is then classified as a user's request for relational data search or a user's request for relational data registration, for example. In case of a request for relational data search, the input information includes a destination of relational data search, a condition for relational data search, a specification for registration/non-registration of relational data search result to the relational data local DB 205, and identification information of the user, for example. In case of a request for relational data registration, the input information includes relational data to be registered and identification information of the user, for example. The input information entered by the user is fed to the control section 203, and then the control section 203 branchingly furnishes the input information to either of the communication section 204 and the relational data local DB 205 in accordance with the kind of the input information and conditions specified therefor (C2). In an instance where the input information is classified as a request for relational data search and a destination of relational data search specified in the input information corresponds to local site destination information of relational data held at the distribution site where the PC 200 is installed (own distribution site), a search is performed in the relational data local DB 205, and then the result of processing (search) is returned to the control section 203 (C3).

In an instance where the input information is classified as a request for relational data search and a destination of relational data search specified in the input information corresponds to center destination information of relational data held at the traceability data center 100 or where the input information is classified as a request for relational data registration, the input information is sent to the traceability data center 100 through the communication section 204, and then the result of processing (registration) at the traceability data center 100 is returned to the control section 203 through the communication section 204.

In an instance where the input information is classified as a request for relational data search, a destination of relational data search specified in the input information corresponds to center destination information of relational data held at the traceability data center 100, and a specification for registration of relational data search result to the relational data local DB 205 is given, the input information is sent to the traceability data center 100 through the communication section 204, and then the result of search processing at the traceability data center 100 is returned to the control section 203 through the communication section 204. Thereafter, the control section 209 registers the relational data search result thus acquired into the relational data local DB 205 (C6).

The result of processing (C7) returned to the control section 203 through any flow regarding steps C3 to C6 is output from the control section 203 to the output section 202 for presentation to the user (C8).

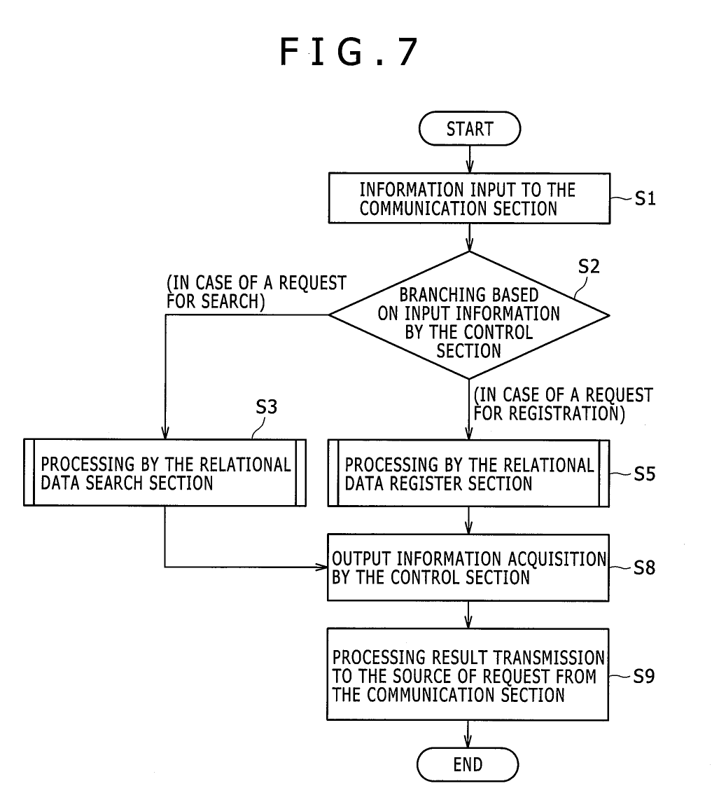

Referring to FIG. 7, there is shown a flowchart of data processing steps to be performed when input information entered to the input section 201 of the PC 200 installed at each distribution site is acquired by the traceability data center 100 through the communication section 204 of the PC 200. Upon receiving input information over the communication network 300 (S1), the communication section 101 of the traceability data center 100 feeds the input information to the control section 102. Then, the control section 102 branchingly furnishes the input information to either one of the relational data search section 103 and the relational data register section 105 in accordance with the kind of the input information and conditions specified therefor (S2).

In an instance where the input information is classified as a request for relational data search, the relational data search section 103 acquires the input information, and accesses the complementary relational data memory DB 107 and the relational data DB 108 to carry out search processing therein. The result of the search processing is returned from the relational data search section 103 to the control section 102 (S3). The result of the processing returned to the control section 102 in step S3 is output from the control section 102 to the communication section 101 (S8), and then the communication section 101 sends the result of the processing to the PC 200 corresponding to the source of request concerned (S9).

In an instance where the input information is classified as a request for relational data registration, the relational data register section 105 acquires the input information, and accesses the relational data DB 108 to carry out registration processing. The result of the registration processing is returned to the control section 102 (S5). The result of the processing returned to the control section 102 in step S5 is output from the control section 102 to the communication section 101, and then the communication section 101 sends the result of the processing to the PC 200 corresponding to the source of request concerned (S9).

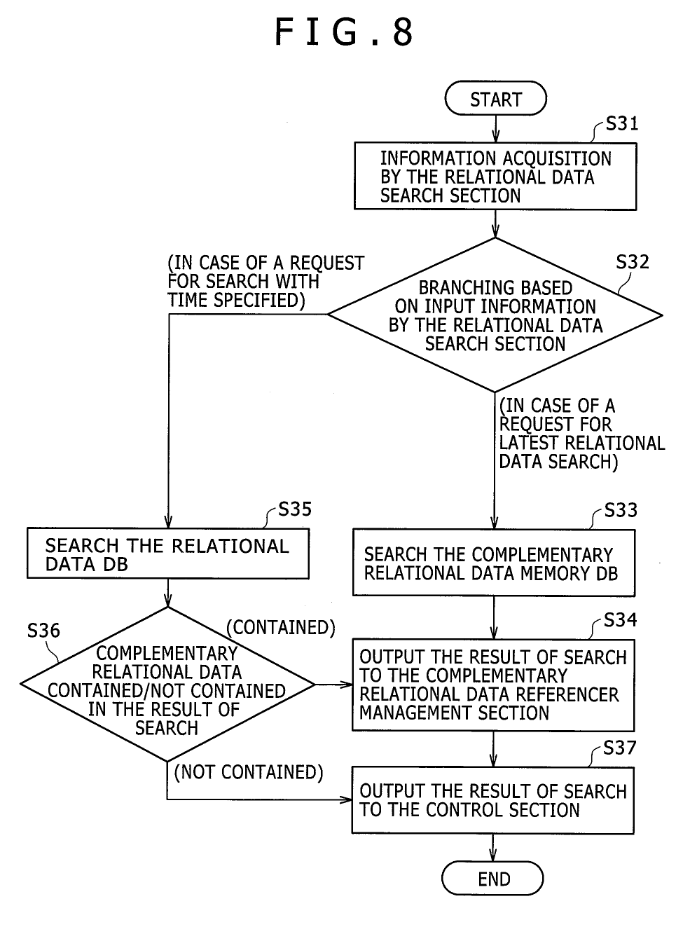

FIG. 8 shows the details of data processing to be carried out in step S3. The input information acquired by the relational data search section 103 (S31) is applied to a branching operation in accordance with the kind of the input information and conditions specified therefor (S32). In an instance where a time-specified search condition is included in relational data search conditions defined in the input information, the relational data search section 103 accesses the relational data DB 108 to carry out search processing in accordance with the time-specified search condition in the input information (S35). If the result of the search processing contains complementary relational data, the complementary relational data contained therein is fed to the complementary relational data referencer management section 106 (S34). Thereafter, the result of the search processing in step S35 is output to the control section 102. Alternatively, if the result of the search processing contains no complementary relational data, control proceeds from step S36 to step S37. Then, the result of the search processing in step S35 is output to the control section 102.

In an instance where a latest relational data search condition is included in relational data search conditions defined in the input information, the relational data search section 103 accesses the complementary relational data memory DB 107 to carry out search processing in accordance with the latest relational data search condition in the input information (S33). Upon completion of the search processing, the result of the search processing is fed to the complementary relational data referencer management section 106 (S34). Thereafter, the result of the search processing in step S33 is output to the control section 102.

Even in cases where the amount of relational data increases, the processing operations mentioned above can prevent an increase in processing time required to search for the latest relational data.

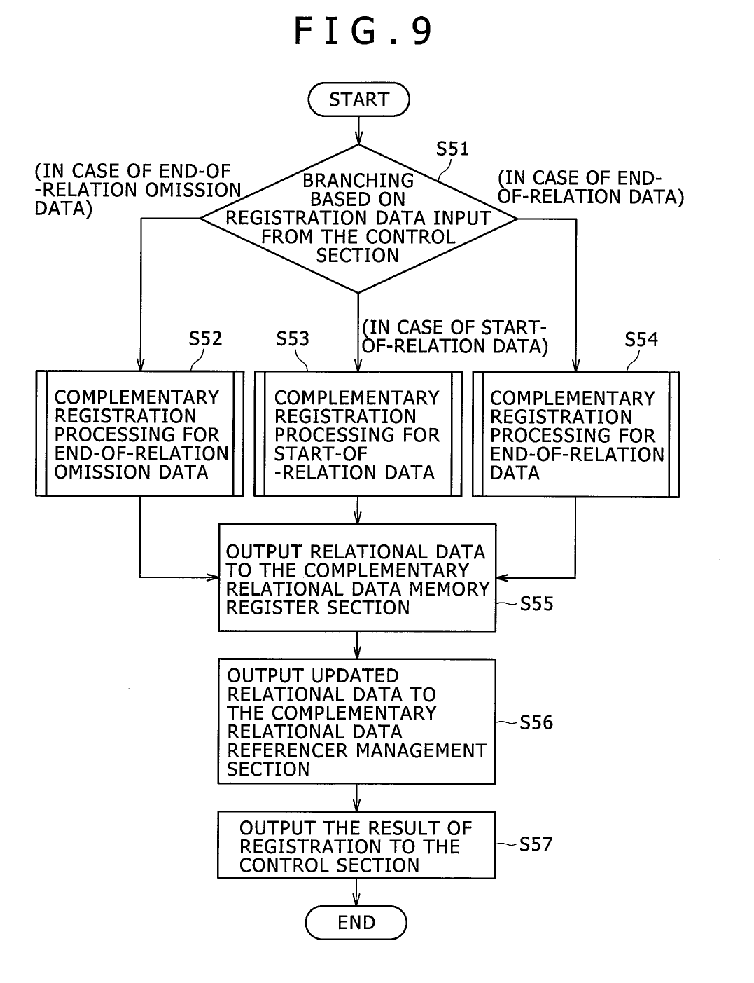

FIG. 9 shows the details of data processing to be carried out in step S5. The input information acquired by the relational data register section 105 is applied to a branching operation in accordance with the kind of the input information and conditions specified therefor (S51).

In an instance where end-of-relation omission data is specified in the input information, the relational data register section 105 accesses the relational data DB 108 to carry out complementary registration processing for the end-of-relation omission data (S52).

In an instance where start-of-relation data is specified in the input information, the relational data register section 105 accesses the relational data DB 108 to carry out complementary registration processing for the start-of-relation data (S53). The start-of-relation data is generated when each commodity item/product is packed in a container case or pallet. Included in the start-of-relation data are identification information of the container case or pallet, identification information of the commodity item/product contained in the container case or pallet, and time information of packing.

In an instance where end-of-relation data is specified in the input information, the relational data register section 105 accesses the relational data DB 108 to carry out complementary registration processing for the end-of-relation data (S54). The end-of-relation data is generated when each commodity item/product is unpacked from a container case or pallet. Included in the end-of-relation data are identification information of the container case or pallet, identification information of the commodity item/product contained in the container case or pallet, and time information of unpacking.

After subjected to complementary registration/updating in any one of steps S52, S53, and S54, the relational data is fed to the complementary relational data memory register section 104 (S55). Thereafter, among relational data stored in the relational data DB 108, the relational data updated in any one of steps S52, S53, and S54 is fed to the complementary relational data referencer management section 106. Then, the result of the complementary registration processing of relational data in any one of steps S52, S53, and S54 is output to the control section 102.

In cases where relational data are not registered in time-series order, the processing operations mentioned above are applicable to complementary registration of relational data, making it possible to provide configuration information that can be estimated from registered contents available at the time of search.

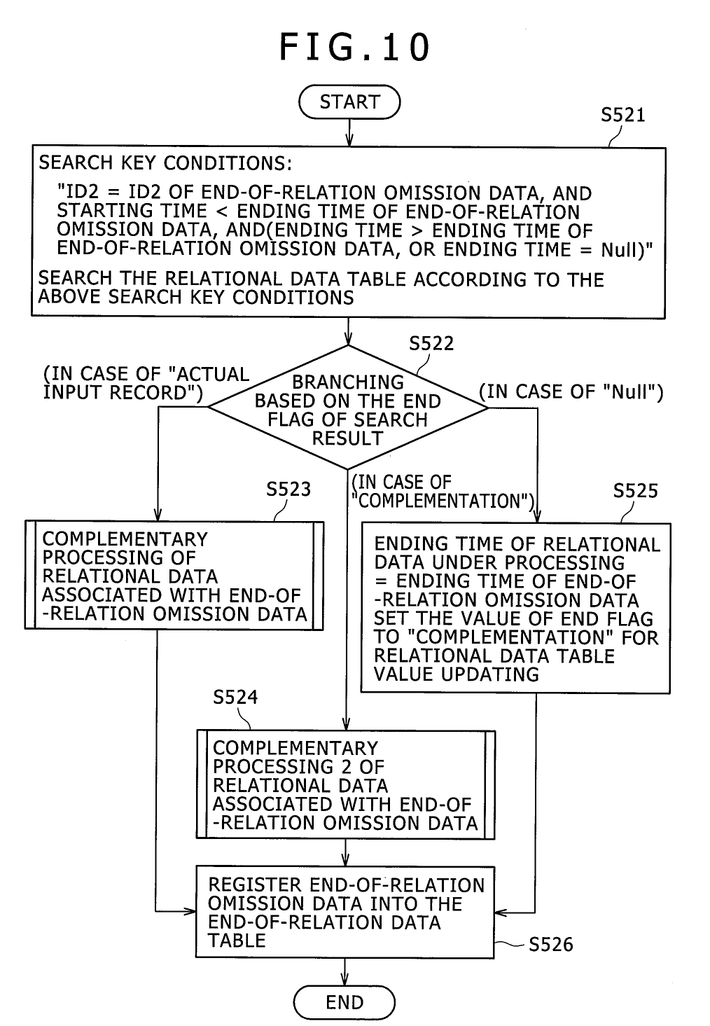

FIG. 10 shows the details of data processing to be carried out in step S52. Based on the end-of-relation omission data acquired, a search is performed in the relational data table 1081 according to the following search key conditions indicated in step S521; “ID2=ID2 of end-of-relation omission data, and Starting time<Ending time of end-of-relation omission data, and (Ending time>Ending time of end-of-relation omission data, or Ending time=Null)”. The result of the search processing in step S521 is applied to a branching operation (S522) according the contents thereof.

For example, if the End flag of relational data in the result of search indicates “Actual input record”, complementary processing is performed on relational data associated with the end-of-relation omission data (S523). After execution of step S523, the end-of-relation omission data is registered in the end-of-relation data table 1082 (S526).

If the End flag of relational data in the result of search indicates “Complementation”, complementary processing 2 is performed on relational data associated with the end-of-relation omission data (S524). After execution of step S524, the end-of-relation omission data is registered in the end-of-relation data table 1082 (S526).

If the End flag of relational data in the result of search indicates “Null”, a branching operation in step S522 is performed to proceed to step S525. In step S525, the ending time of relational data under processing is assigned as the ending time of end-of-relation omission data, and the End flag is set to a value indicating “Complementation” for updating (S525). Thereafter, the end-of-relation omission data is registered in the end-of-relation data table 1082 (S526). The processing steps subsequent to step S522 are carried out for all the relational data acquired in search processing in step S521.

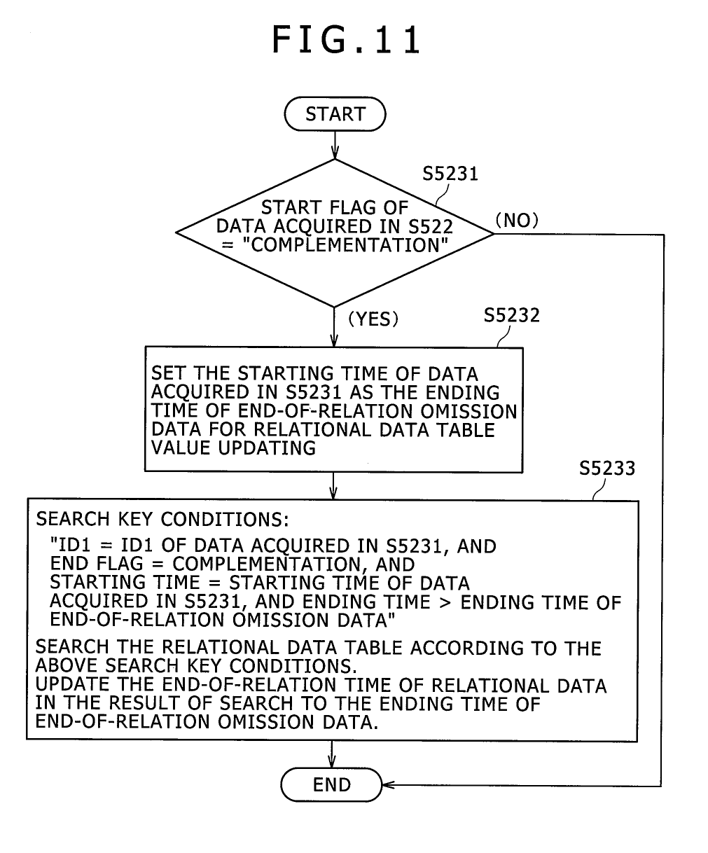

FIG. 11 shows the details of complementary processing of relational data associated with the end-of-relation omission data in step S523. A branching operation is performed according to whether or not the Start flag of relational data acquired in step S522 has a value indicating “Complementation” (S5231).

If the Start flag has a value indicating “Complementation”, the starting time of relational data under processing is assigned as the ending time of end-of-relation omission data for registration updating in the relational data table 1081 (S5232). Thereafter, a search is performed in the relational data table 1081 according to the following search key conditions indicated in step S5233; “ID1=ID1 of data acquired in S5231, and End flag=Complementation, and Starting time=Starting time of data acquired in S5231, and Ending time>Ending time of end-of-relation omission data”. The end-of-relation time of relational data in the result of search in step S5233 is assigned as the ending time of end-of-relation omission data for registration updating in the relational data table 1081. Alternatively, if the Start flag does not has a value indicating “Complementation”, the processing in step S523 comes to an end without registration updating.

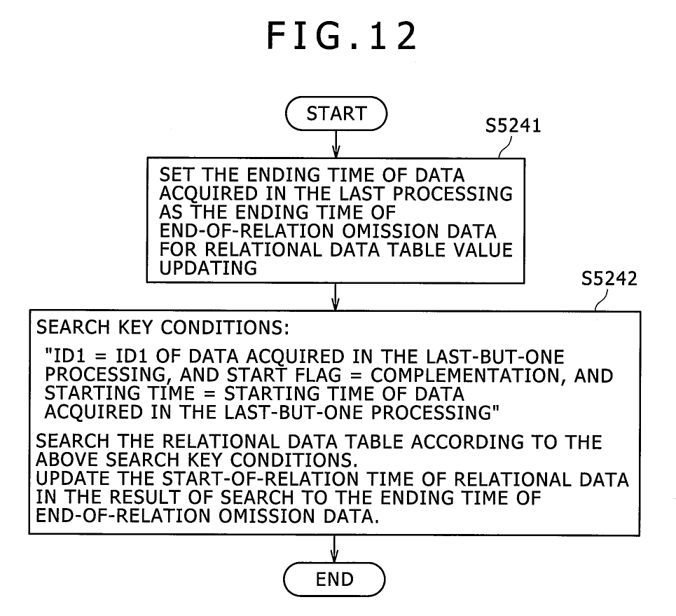

FIG. 12 shows the details of complementary processing 2 of relational data associated with the end-of-relation omission data in step S524. The ending time of relational data acquired in step S522 is assigned as the ending time of end-of-relation omission data for registration updating in the relational data table 1081 (S5241). Thereafter, a search is performed in the relational data table 1081 according to the following search key conditions indicated in step S5242; “ID1=ID1 of data acquired in the last-but-one processing, and Start flag=Complementation, and Starting time=Starting time of data acquired in the last-but-one processing”. The start-of-relation time of relational data in the result of search in step S5242 is assigned as the ending time of end-of-relation omission data for registration updating in the relational data table 1081. It is to be noted that registration updating of the above and other entry elements may be made in any fashion or manner such as record overwriting or separate record creation.

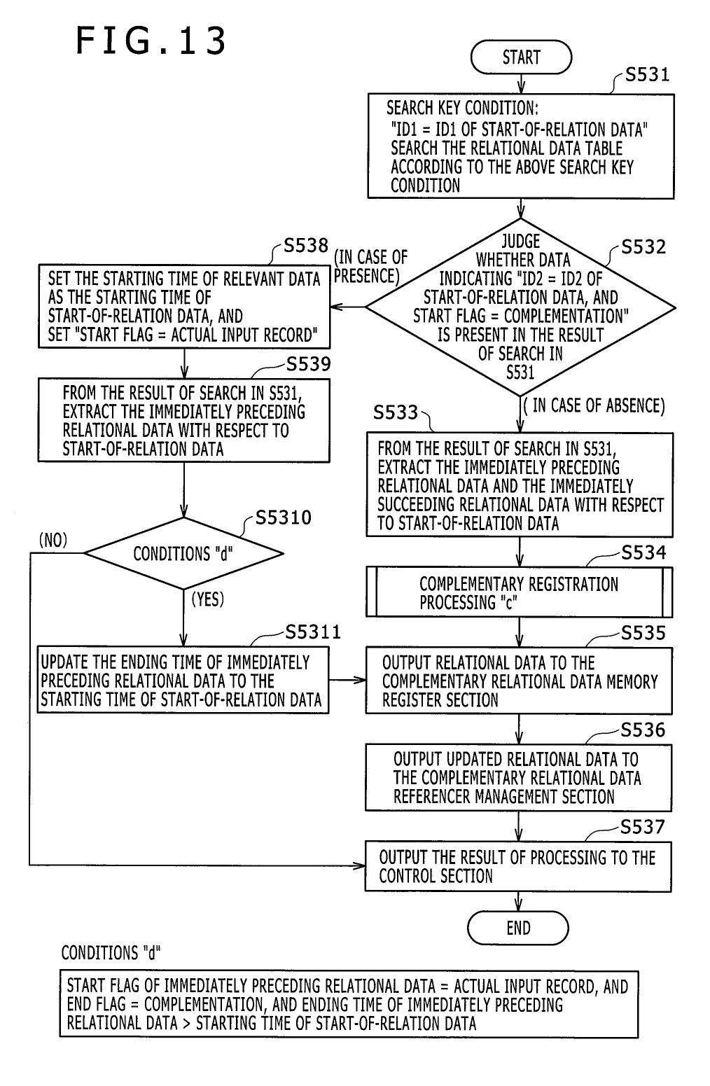

FIG. 13 shows the details of data processing to be carried out in step S53. Based on the start-of-relation data acquired, a search is performed in the relational data table 1081 according to the following search key condition indicated in step S531; “ID1=ID1 of start-of-relation data”. The result of search in step S531 is applied to a branching operation to be performed on conditions indicated in step S532 (S532).

In a case where data meeting the conditions indicated in step S532 is present in the result of search in step S531, the starting time of the data is assigned as the starting time of start-of-relation data, and the Start flag is set to a value indicating “Actual input record” for registration updating in the relational data table 1081 (S538).

Thereafter, immediately preceding relational data with respect to the start-of-relation data is extracted from the result of search in step S531 (S539). The immediately preceding relational data in this case refers to relational data having information of the latest starting time that precedes the starting time of start-of-relation data among relational data included in the result of search. The immediately preceding relational data extracted in step S539 is applied to a branching operation to be performed on the following conditions “d”; “Start flag of immediately preceding relational data=Actual input record, and End flag=Complementation, and Ending time of immediately preceding relational data>Starting time of start-of-relation data” (S5310).

If the immediately preceding relational data meets the conditions “d”, the ending time of the immediately preceding relational data is assigned as the starting time of start-of-relation data for registration updating in the relational data table 1081. Thereafter, relational data subjected to update processing in step S5311 is fed to the complementary relational data memory register section 104 (S535). If the immediately preceding relational data (registered data) does not meet the conditions “d”, the result of processing is output to the control section 102 (S537).

In a case where data meeting the conditions indicated in step S532 is absent in the result of search in step S531, immediately preceding relational data and immediately succeeding relational data with respect to the start-of-relation data are extracted from the result of search in step S531 (S533). The immediately succeeding relational data in this case refers to relational data having information of the latest starting time that succeeds the starting time of start-of-relation data among relational data included in the result of search. The immediately preceding relational data and the immediately succeeding relational data extracted in step S533 are applied to complementary registration processing “c” (S534). Thereafter, relational data registered in step S534 is fed to the complementary relational data memory register section 104. After processing in step S535, relational data updated in the relational data table 1081 is fed to the complementary relational data referencer management section 106 (S536). Then, the result of processing is output to the control section 102 (S537).

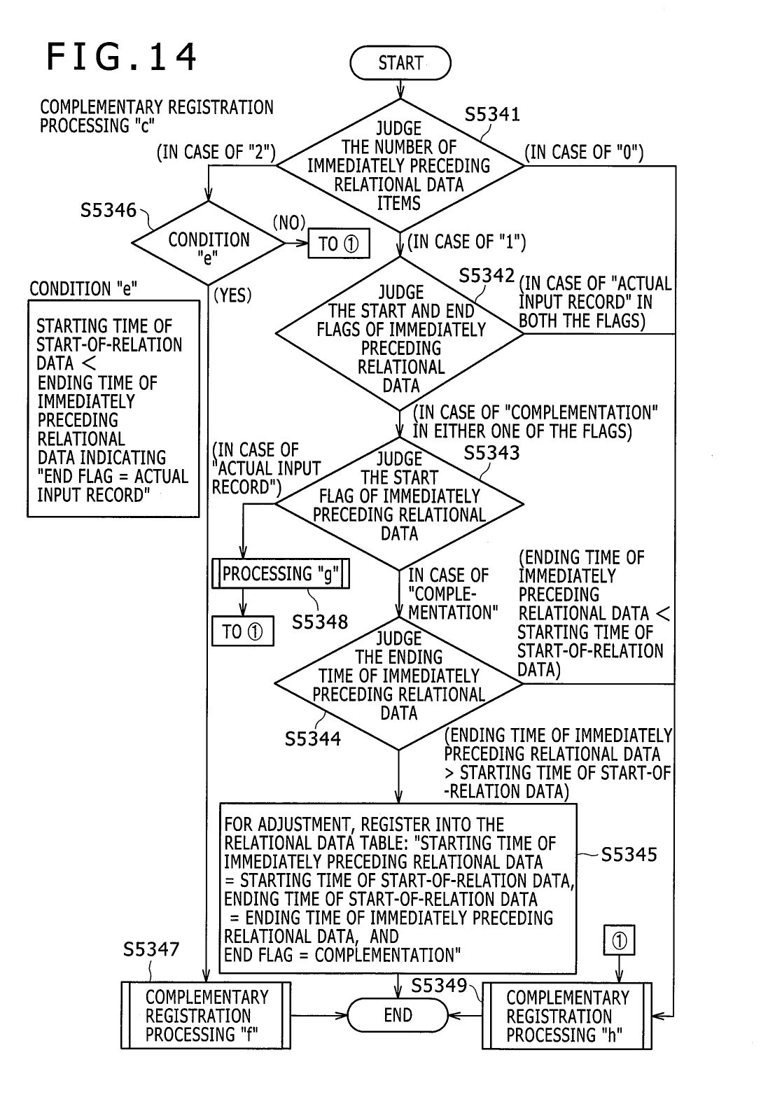

FIG. 14 shows the details of complementary registration processing “c” to be carried out in step S534. According to the number of immediately preceding relational data items extracted in step S533, a branching operation is performed (S5341). Then, in a case where the number of immediately preceding relational data items extracted is “2”, a branching operation is performed on the following condition “e”; “Starting time of start-of-relation data<Ending time of immediately preceding relational data indicating (End flag=Actual input record)” (S5346). If the immediately preceding relational data extracted meets the condition “e”, complementary registration processing “f” is carried out (S5347). Then, upon completion of the complementary registration processing “f”, the complementary registration processing “c” comes to an end. If the immediately preceding relational data extracted does not meet the condition “e”, complementary registration processing “h” is carried out (S5349). Then, upon completion of the complementary registration processing “h”, the complementary registration processing “c” comes to an end.

In a case where the number of immediately preceding relational data items extracted is “1”, a branching operation is performed according to the values of the Start flag and End flag of the relational data (S5342).

If the values of both the Start flag and End flag indicate “Actual input record”, complementary registration processing “h” is carried out (S5349). Then, upon completion of the complementary registration processing “h”, the complementary registration processing “c” comes to an end. If the value of either the Start flag or End flag indicates “Complementation”, a branching operation is performed according to the value of the Start flag of the relational data (S5343). If the value of the Start flag of the relational data indicates “Actual input record”, complementary registration processing “g” is carried out (S5348). Then, upon completion of the complementary registration processing “g”, the complementary registration processing “h” is carried out (S5349), and upon completion of the complementary registration processing “h”, the complementary registration processing “c” comes to an end. If the value of the Start flag of the relational data indicates “Complementation”, a branching operation is performed according to the ending time of the relational data (S5344). If the ending time of the relational data is earlier than the starting time of start-of-relation data, the complementary registration processing “h” is carried out (S5349). Then, upon completion of the complementary registration processing “h”, the complementary registration processing “c” comes to an end. If the ending time of the relational data is later then the starting time of start-of-relation data, the starting time of the relational data is assigned as the starting time of start-of-relation data for registration updating in the relational data table 1081. Further, the ending time of start-of-relation data is assigned as the ending time of the relational data, and the End flag is set to “Complementation” for registration in the relational data table 1081 (S5345). Thus, the complementary registration processing “c” comes to an end. In a case where the number of immediately preceding relational data items extracted is “0”, control proceeds straight to the complementary registration processing “h” (S5349). Then, upon completion of the complementary registration processing “h”, the complementary registration processing “c” comes to an end.

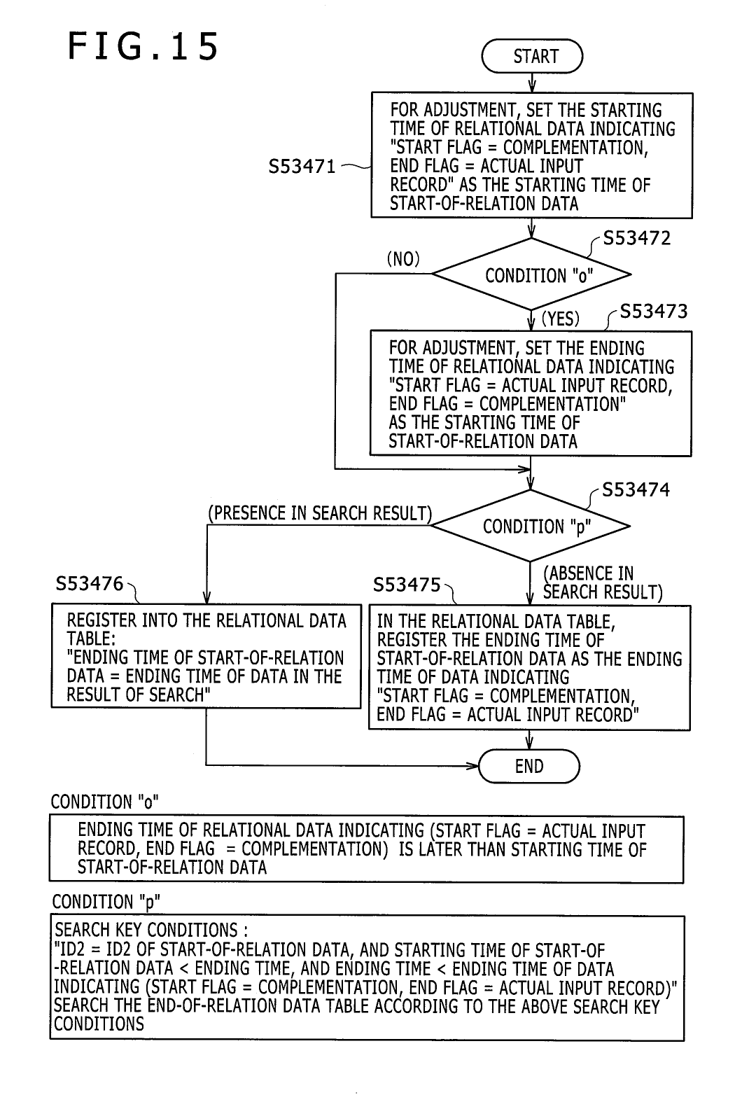

FIG. 15 shows the details of complementary registration processing “f” to be carried out in step S5347. Through selection between the two immediately preceding relational data items acquired in step S5341, the starting time of relational data meeting the conditions that the value of the Start flag indicates “Complementation” and the value of the End flag indicates “Actual input record” is assigned as the starting time of start-of-relation data for registration updating in the relational data table 1081. Then, a branching operation is performed on the following condition “o”; “Ending time of relational data indicating (Start flag=Actual input record, End flag=Complementation) is later than starting time of start-of-relation data” (S53472). If the condition “o” is satisfied, the ending time of relational data indicating that the value of the Start flag is “Actual input record” and the value of the End flag is “Complementation” (one of the two immediately preceding relational data items acquired in step S5341) is assigned as the starting time of start-of-relation data for registration updating in the relational data table 1081 (S53473). Further, a branching operation is performed on the following conditions “p”; “Presence/absence in result of search in the end-of-relation data table according to the search key conditions “ID2=ID2 of start-of-relation data, and Starting time of start-of-relation data<Ending time, and Ending time<Ending time of data indicating (Start flag=Complementation, End flag=Actual input record)” (S53474).

If the condition “o” is not satisfied, the processing in step S53473 is skipped over and a branching operation is performed on the conditions “p” (S53474). According to the search key conditions indicated as the conditions “p”, a search is made in the end-of-relation data table 1082 for relevant relational data. If the relevant relational data is acquired, the ending time of start-of-relation data is registered in the relational data table 1081 as the ending time of the acquired relational data (S53476). Thus, the complementary registration processing “f” comes to an end. If the relevant relational data is not found in the result of searching the end-of-relation data table 1082 according to the search key conditions indicated as the conditions “p”, the ending time of start-of-relation data is registered in the relational data table 1081 as the ending time of relational data indicating that the value of the Start flag is “Complementation” and the value of the End flag is “Actual input record” (one of the two immediately preceding relational data items acquired in step S5341) (S53475). Thus, the complementary registration processing “f” comes to an end.

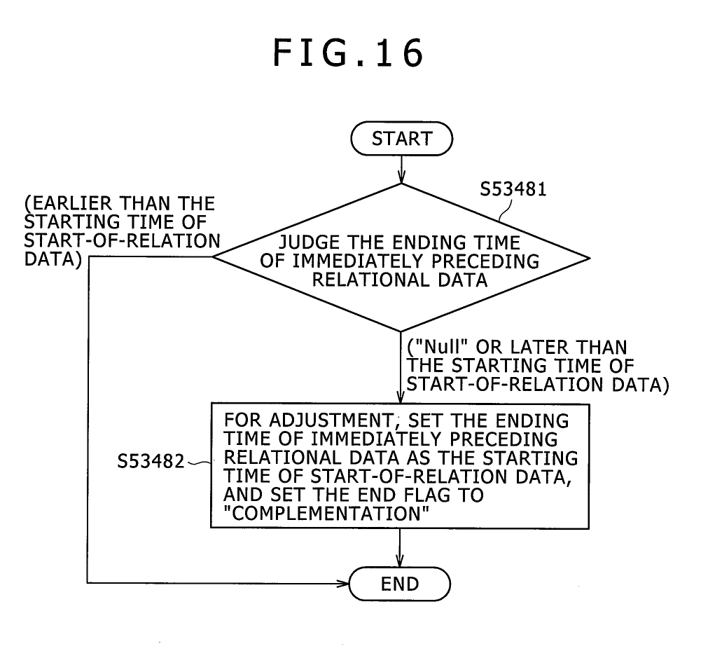

FIG. 16 shows the details of complementary registration processing “g” to be carried out in step S5348. A branching operation is performed according to the ending time of immediately preceding relational data acquired in step S5343 (S53481). If the ending time of the immediately preceding relational data is earlier than the starting time of start-of-relation data, the flow of the complementary registration processing “g” proceeds straight to an end. If the ending time of the immediately preceding relational data is “Null” or later than the starting time of start-of-relation data, the ending time of the immediately preceding relational data is assigned as the starting time of start-of-relation data, and the End flag of the immediately preceding relational data is set to “Complementation” for registration updating in the relational data table 1081 (S53482).

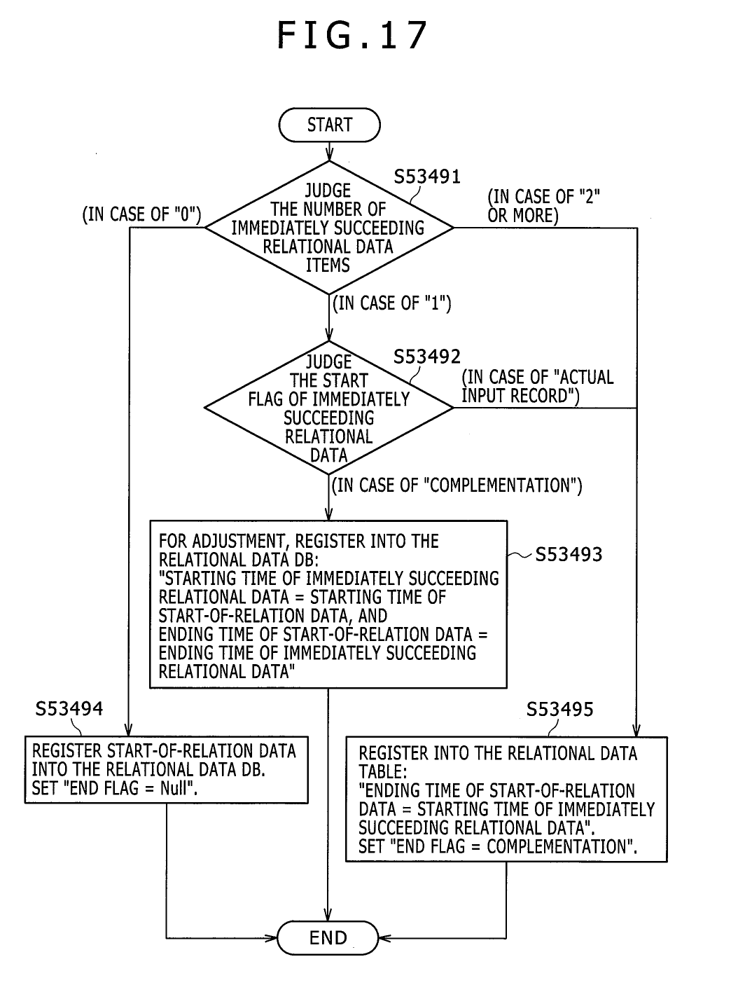

FIG. 17 shows the details of complementary registration processing “h” to be performed in step S5349. A branching operation is performed according to the number of immediately succeeding relational data items extracted in step S533 (S53491). In a case where the number of immediately succeeding relational data items extracted is “2” or more, the ending time of start-of-relation data is assigned as the starting time of the immediately succeeding relational data, and the End flag of start-of-relation data is set to “Complementation” for registration in the relational data table 1081 (S53495). Thus, the complementary registration processing “h” comes to an end.

In a case where the number of immediately succeeding relational data items extracted is “1”, a branching operation is performed according to the Start flag of the immediately succeeding relational data (S53492). If the value of the Start flag indicates “Actual input record”, the processing in step S53495 is carried out. Upon completion of the processing in step S53495, the complementary registration processing “h” comes to an end. If the value of the Start flag indicates “Complementation”, the starting time of the immediately succeeding relational data is assigned as the starting time of start-of-relation data for registration updating in the relational data table 1081. Further, the ending time of start-of-relation data is assigned as the ending time of the immediately succeeding relational data for registration in the relational data table 1081 (S53493). Thus, the complementary registration processing “h” comes to an end.

In a case where the number of immediately succeeding relational data items is “0”, the ending time of start-of-relation data is set to “Null” and the End flag is set to “Null” for registration in the relational data table 1081 (S53494). Thus, the complementary registration processing “h” comes to an end.

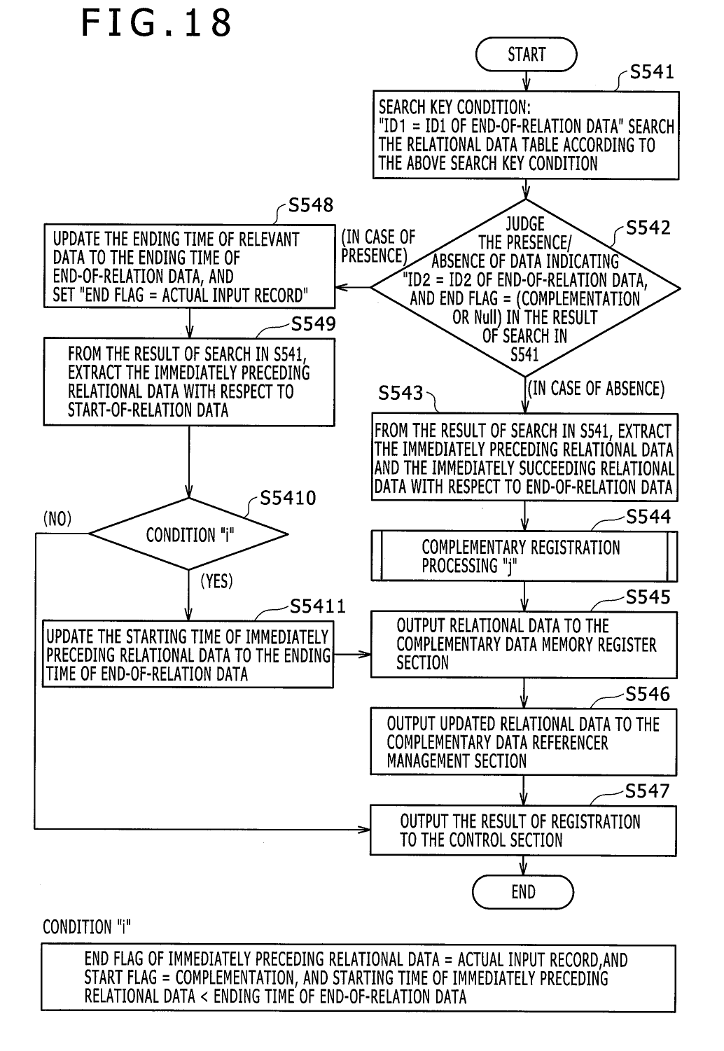

FIG. 18 shows the details of data processing to be carried out in step S54. Based on the end-of-relation data acquired, a search is performed in the relational data table 1081 according to the following search key condition indicated in step S541; “ID1=ID1 of end-of-relation data”. The result of search in step S541 is applied to a branching operation to be performed on the conditions indicated in step S542; “Judge the presence/absence of data indicating “ID2=ID2 of end-of-relation data, and End flag=(Complementation or Null) in the result of search in S541” (S542).

In a case where data meeting the conditions indicated in step S542 is present in the result of search in step S541, the ending time of the data is assigned as the starting time of end-of-relation data, and the End flag is set to “Actual input record” for registration updating in the relational data table 1081 (S548). Thereafter, immediately preceding relational data with respect to the end-of-relation data is extracted from the result of search in step S541 (S549). The immediately preceding relational data in this case refers to relational data having information of the latest starting time that precedes the starting time of end-of-relation data among relational data included in the result of search. The immediately preceding relational data extracted in step S549 is applied to a branching operation to be performed on the following conditions “i”; “End flag of immediately preceding relational data=Actual input record, and Start flag=Complementation, and Starting time of immediately preceding relational data<Ending time of end-of-relation data” (S5410).

If the immediately preceding relational data meets the conditions “i”, the starting time of the immediately preceding relational data is assigned as the ending time of end-of-relation data for registration updating in the relational data table 1081. Thereafter, relational data subjected to update processing in step S5411 is fed to the complementary relational data memory register section 104 (S545). If the immediately preceding relational data does not meet the conditions “i”, the result of processing is output to the control section 102 (S547).

In a case where data meeting the conditions indicated in step S542 is absent in the result of search in step S541, immediately preceding relational data and immediately succeeding relational data with respect to the end-of-relation data are extracted from the result of search in step S541 (S543). The immediately succeeding relational data in this case refers to data having information of the latest starting time that succeeds the starting time of end-of-relation data among relational data included in the result of search. The immediately preceding relational data and the immediately succeeding relational data extracted in step S543 are applied to complementary registration processing “j” (S544). Thereafter, relational data registered in step S544 is fed to the complementary relational data memory register section 104. After processing in step S545, relational data updated in the relational data table 1081 is fed to the complementary relational data referencer management section 106 (S546). Then, the result of processing is output to the control section 102 (S547).

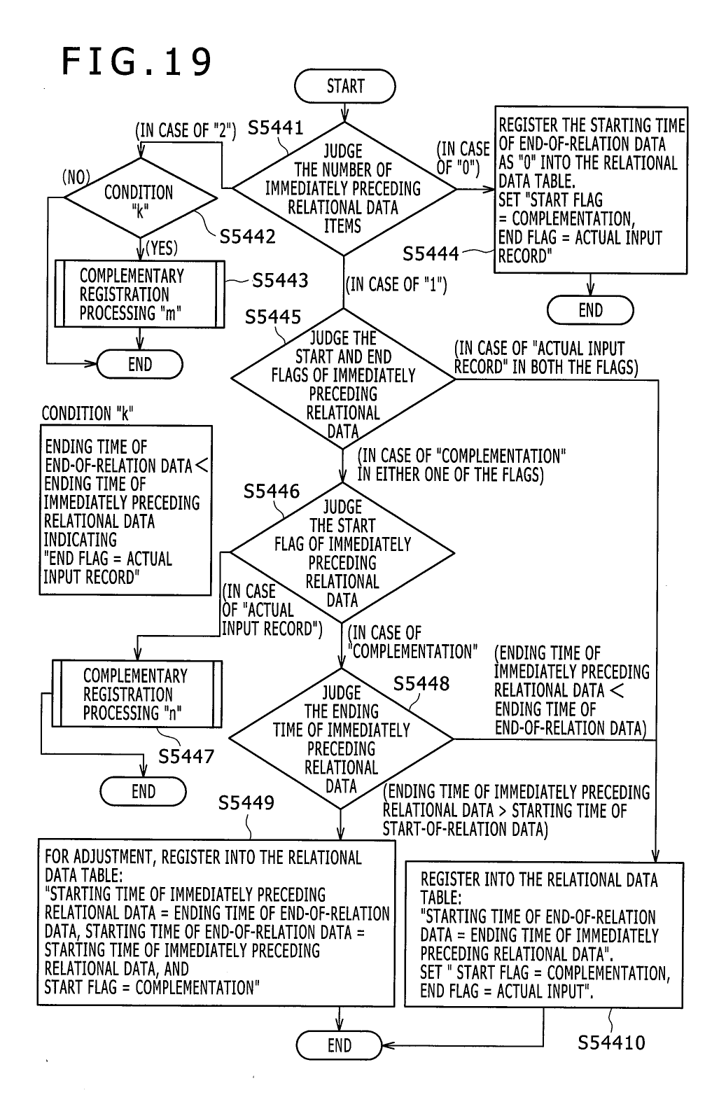

FIG. 19 shows the details of complementary registration processing “j” to be carried out in step S544. According to the number of immediately preceding relational data items extracted in step S543, a branching operation is performed (S5441).

Then, in a case where the number of immediately preceding relational data items extracted is “2”, a branching operation is performed on the following condition “k”; “Ending time of end-of-relation data<Ending time of immediately preceding relational data indicating (End flag=Actual input record)” (S5442). If the immediately preceding relational data extracted meets the condition “k”, complementary registration processing “m” is carried out (S5443). Then, upon completion of the complementary registration processing “m”, the complementary registration processing “j” comes to an end. If the immediately preceding relational data extracted does not meet the condition “k”, the flow of the complementary registration processing “j” proceeds straight to an end.

In a case where the number of immediately preceding relational data items extracted is “1”, a branching operation is performed according to the values of the Start flag and End flag of the relational data (S5445)

If the values of both the Start flag and End flag indicate “Actual input record”, the starting time of end-of-relation data is assigned as the ending time of the immediately preceding relational data, the value of the Start flag is set to “Complementation”, and the value of the End flag is set to “Actual input record” for registration in the relational data table 1081 (S54410). Thus, the complementary registration processing “j” comes to an end. If the value of either the Start flag or End flag indicates “Complementation”, a branching operation is performed according to the value of the Start flag of the relational data (S5446). If the value of the Start flag of the relational data indicates “Actual input record”, complementary registration processing “n” is carried out (S5447). Then, upon completion of the complementary registration processing “n”, the complementary registration processing “j” comes to an end. If the value of the Start flag of the relational data indicates “Complementation”, a branching operation is performed according to the ending time of the relational data (S5448). If the ending time of the relational data is earlier than the ending time of end-of-relation data, the processing in step S54410 is carried out. Then, upon completion of the processing in step S54410, the complementary registration processing “j” comes to an end. If the ending time of the relational data is later than the starting time of end-of-relation data, the starting time of the relational data is assigned as the ending time of end-of-relation data for registration updating in the relational data table 1081. Further, the starting time of end-of-relation data is assigned as the starting time of the relational data, and the Start flag of end-of-relation data is set to “Complementation for registration in the relational data table 1081 (S5449). Thus, the complementary registration processing “j” comes to an end.

In a case where the number of immediately preceding relational data items extracted is “0”, the starting time of end-of-relation data is set to “0”, and the Start flag is set to “Complementation” for registration in the relational data table 1081 (S5444). Thus, the complementary registration processing “j” comes to an end.

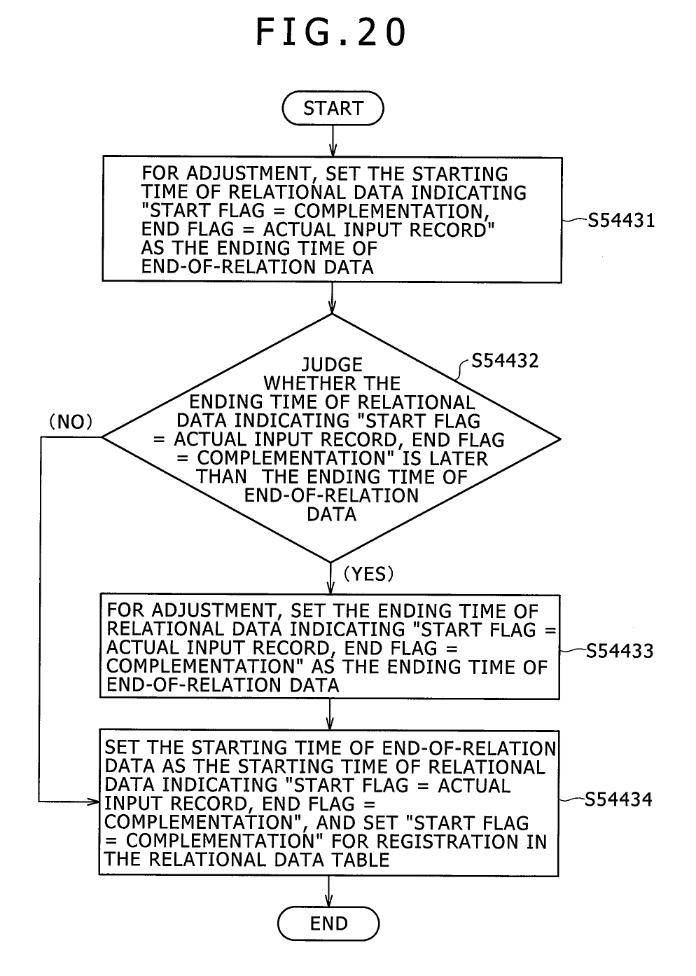

FIG. 20 shows the details of complementary registration processing “m” to be carried out in step S5443. Through selection between the two immediately preceding relational data items acquired in step S5441, the starting time of relational data meeting the conditions that the value of the Start flag indicates “Complementation” and the value of the End flag indicates “Actual input record” is assigned as the ending time of end-of-relation data for registration updating in the relational data table 1081 (S54431). Then, a branching operation is performed on the following condition indicated in step S54432; “Judge whether the ending time of relational data indicating (Start flag=Actual input record, End flag=Complementation) is later than the ending time of end-of-relation data” (S54432). If the above condition indicated in step S54432 is satisfied, the ending time of relational data indicating that the value of the Start flag is “Actual input record” and the value of the End flag is “Complementation” (one of the two immediately preceding relational data items acquired in step S5441) is assigned as the ending time of end-of-relation data for registration updating in the relational data table 1081 (S53473). Further, the starting time of end-of-relation data is assigned as the starting time of relational data indicating that the value of the Start flag is “Actual input record” and the value of the End flag is “Complementation (one of the two immediately preceding relational data items acquired in step S5411), and the value of the Start flag is set to “Complementation” for registration in the relational data table 1081 (S54434). Thus, the complementary registration processing “m” comes to an end. If the condition indicated in step S54432 is not satisfied, the flow of the complementary registration processing “m” proceeds straight to an end.

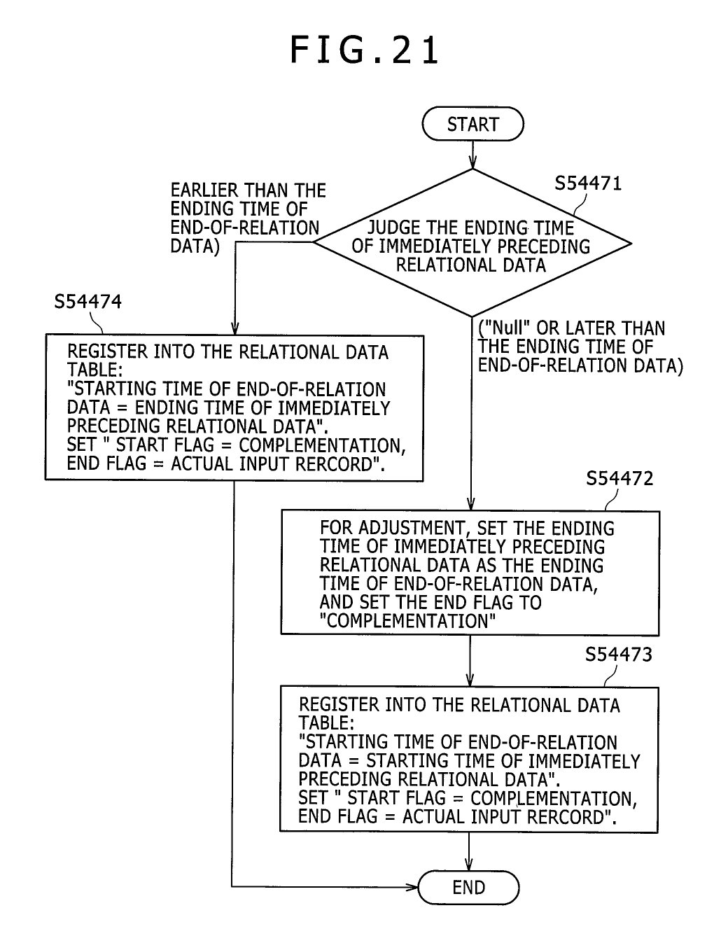

FIG. 21 shows the details of complementary registration processing “n” to be carried out in step S5447. A branching operation is performed according to the ending time of immediately preceding relational data acquired in step S5446 (S54471). If the ending time of the immediately preceding relational data is earlier than the ending time of end-of-relation data, the starting time of end-of-relation data is assigned as the ending time of the immediately preceding relational data, the value of the Start flag is set to “Complementation”, and the value of the End flag is set to “Actual input record” for registration in the relational data table 1081 (S54474). Thus, the complementary registration processing “n”” comes to an end. If the ending time of the immediately preceding relational data is “Null” or later than the ending time of end-of-relation data, the ending time of the immediately preceding relational data is assigned as the ending time of end-of-relation data, and the value of the End flag of the immediately preceding relational data is set to “Complementation for registration updating in the relational data table 1081 (S54472). Further, the starting time of end-of-relation data is assigned as the starting time of the immediately preceding relational data, the value of the Start flag is set to “Complementation”, and the value of the End flag is set to “Actual input record” for registration in the relational data table 1081 (S54473). Thus, the complementary registration processing “n” comes to an end.

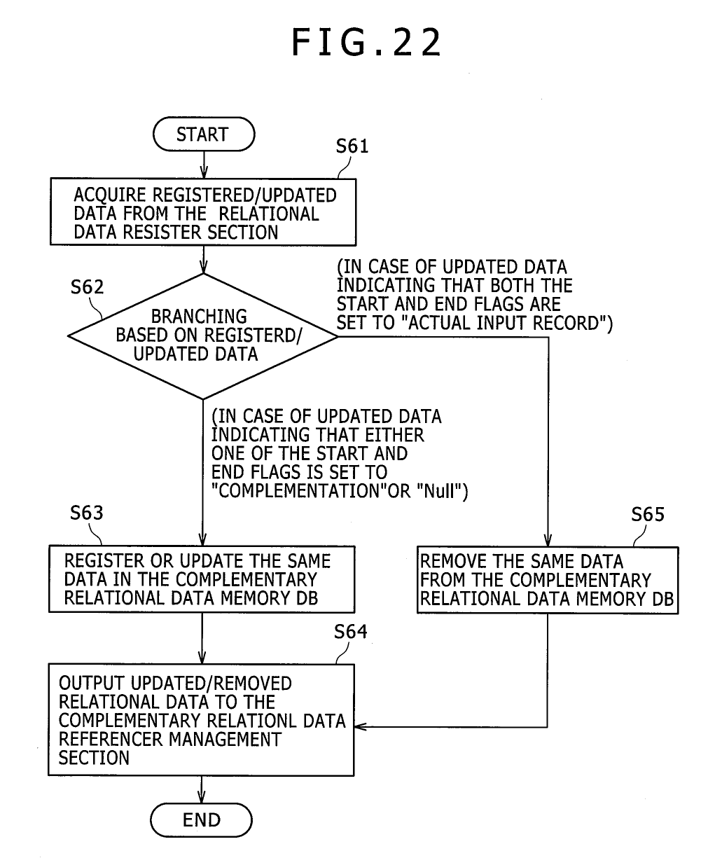

FIG. 22 shows the details of data processing at the complementary relational data memory register section 104. The complementary relational data memory register section 104 acquires relational data registered/updated in the relational data DB 108 from the relational data register section 105 (S61). According to the contents of the relational data acquired from the relational data register section 105, a branching operation is performed (S62). If the relational data acquired from the relational data register section 105 is provided as registered/updated data indicating that either one of the Start flag and the End flag is set to “Complementation” or “Null”, the same data is fed to the complementary relational data memory DB for registration/updating (S63). If the relational data acquired from the relational data register section 105 is provided as updated data indicating that both the Start flag and End flag are set to “Actual input record”, the same data held in the complementary relational data memory DB 107 is removed (S65). The relational data updated/removed in step S63 or step S65 is output to the complementary relational data referencer management section 106. Thus, the complementary relational data memory register section 104 completes processing thereof.

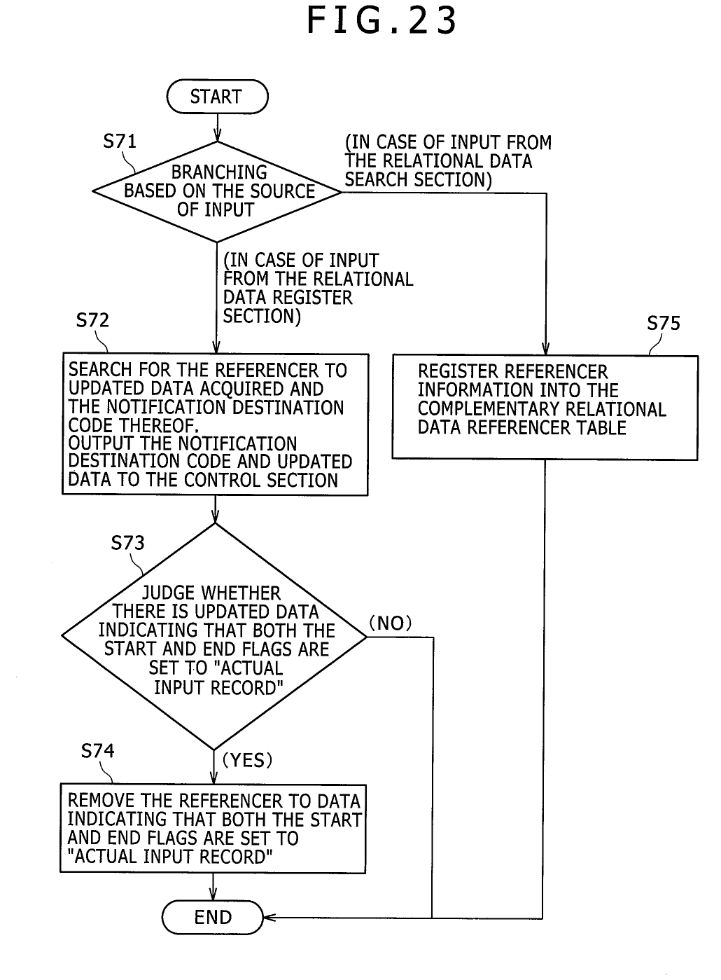

FIG. 23 shows the details of data processing at the complementary relational data referencer management section 106. The complementary relational data referencer management section 106 performs a branching operation according to the source of input thereto (S71). In case of input from the relational data search section 103, identification information of a referencer and identification information of relational data referenced by searching are registered into the complementary relational data referencer table 1091 (S75). Thus, the complementary relational data referencer management section 106 completes processing thereof. In case of input from the relational data register section 105, the complementary relational data referencer management section 106 accesses the complementary relational data referencer DB 109 to search for a referencer to relational data acquired and a notification destination code thereof. The notification destination code in the result search and the relational data are output to the control section 102 (S72). Then, the complementary relational data referencer management section 106 performs a branching operation according to the contents of the relational data output to the control section 102 (S73). If the relational data output to the control section 102 contains data indicating that both the Start flag and End flag are set to “Actual input record”, identification information of the referencer to the relational data and the notification destination code thereof are removed from the complementary relational data referencer table 1091 (S74). Thus, the complementary relational data referencer management section 106 completes processing thereof. If the relational data output to the control section 102 does not contain data indicating that both the Start flag and End flag are set to “Actual input record”, the complementary relational data referencer management section 106 skips over step S74 to terminate processing thereof.

The following describes exemplary data processing in a situation where relational data regarding packing and unpacking processes shown in FIG. 2 have not been registered in time-series order. The description given below is based on the assumption that start-of-relation data indicating clock time 1:00, start-of-relation data indicating clock time 3:00, end-of-relation data indicating clock time 4:00, end-of-relation data indicating clock time 5:00, and end-of-relation data indicating clock time 2:00 are registered successively as mentioned. It is also assumed that the relational data table 1081 stored in the relational data DB 108 is referenced by a user having identification information “userA” after registration of the relational data indicating clock time 4:00.

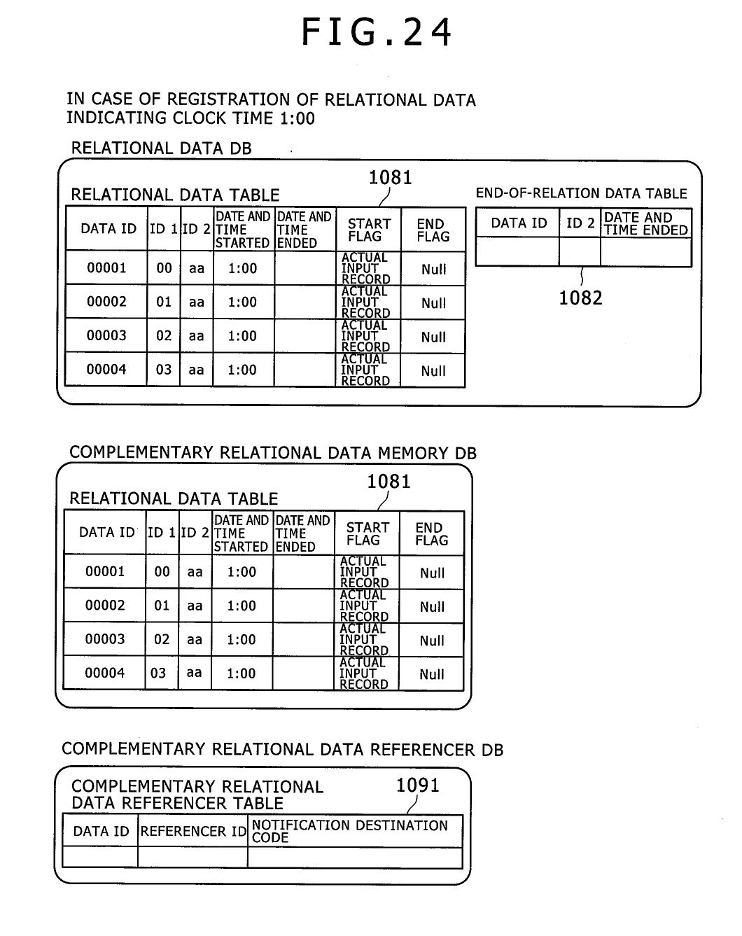

Referring now to FIG. 24, there is shown an example of registration of start-of-relation data indicating clock time 1:00. Relational data of container case aa and each of product 00, product 01, product 02, and product 03 are registered in the relational data table 1081 stored in each of the relational data DB 108 and the complementary relational data memory DB 107.

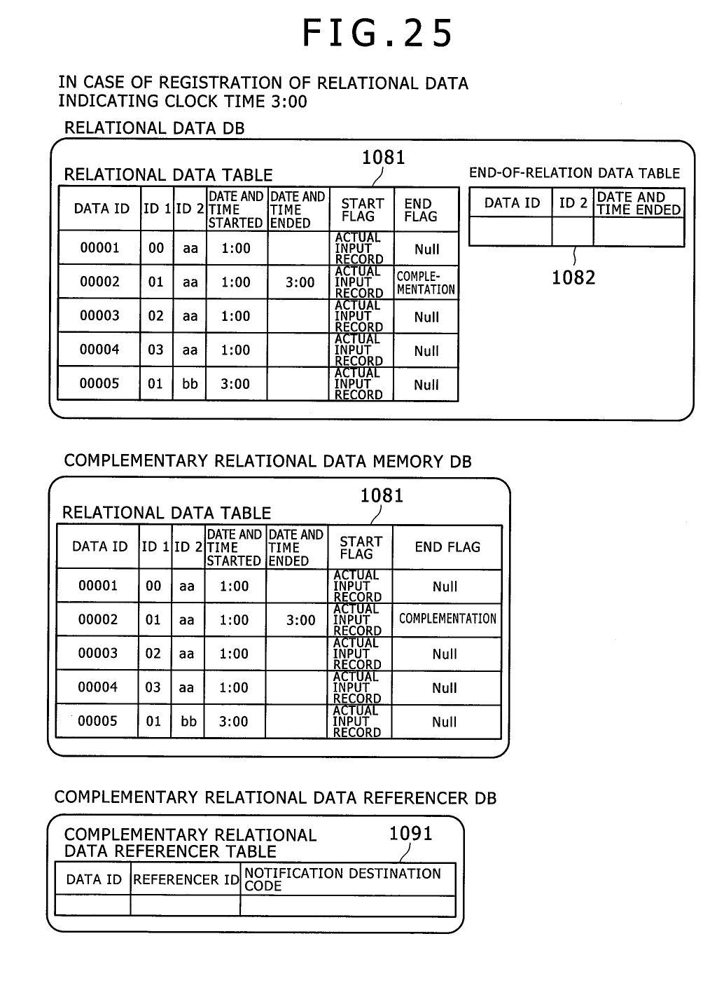

Referring to FIG. 25, there is shown an example of registration of end-of-relation data indicating clock time 3:00. Relational data of container case bb and product 01 is registered in the relational data table 1081 stored in each of the relational data DB 108 and the complementary relational data memory DB 107. A complement time value “3:00” is entered in the element “Date and time ended” of the relational data of container case aa and product 01.

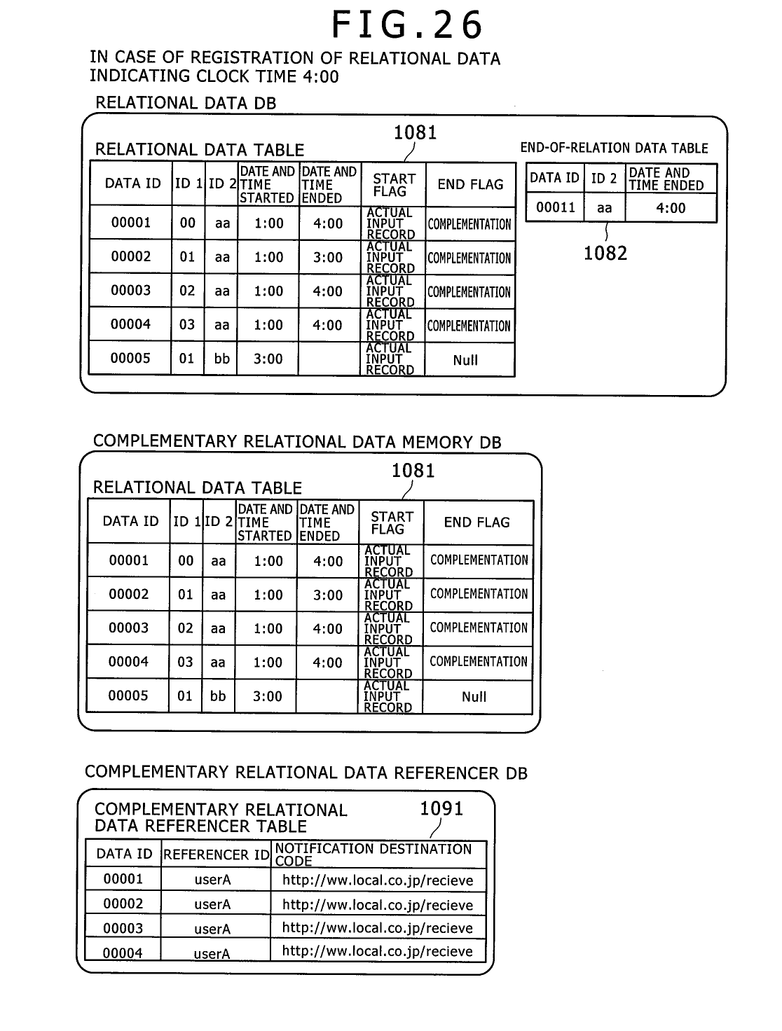

Referring to FIG. 26, there is shown an example of registration of end-of-relation omission data indicating clock time 4:00. A complement time value “4:00” is entered in the element “Date and time ended” of the relational data of container case aa and each of product 00, product 02, and product 03 in the relational data table 1081 stored in each of the relational data DB 108 and the complementary relational data memory DB 107. Further, the end-of-relation omission data indicating clock time 4:00 is registered in the end-of-relation data table 1082. After registration of the end-of-relation omission data indicating clock time 4:00, if the user having identification information “userA” makes a search request for “configuration information of container case aa at clock time 3:00” to the traceability data center 100, the relational data table 1081 stored in the relational data DB 108 is searched, and relational data having Data ID codes 00001, 00002, 00003, and 00004 are returned. Since each of these relational data is complementary relational data indicating the time of complementation as the ending time, the relevant Data ID code, the Referencer ID code “userA”, and the Notification destination code (destination for notification of complementary relational data updating to the referencer, e.g., URL “http://ww.local.co.jp/receive” or the like) are registered in the complementary relational data referencer table 1091.

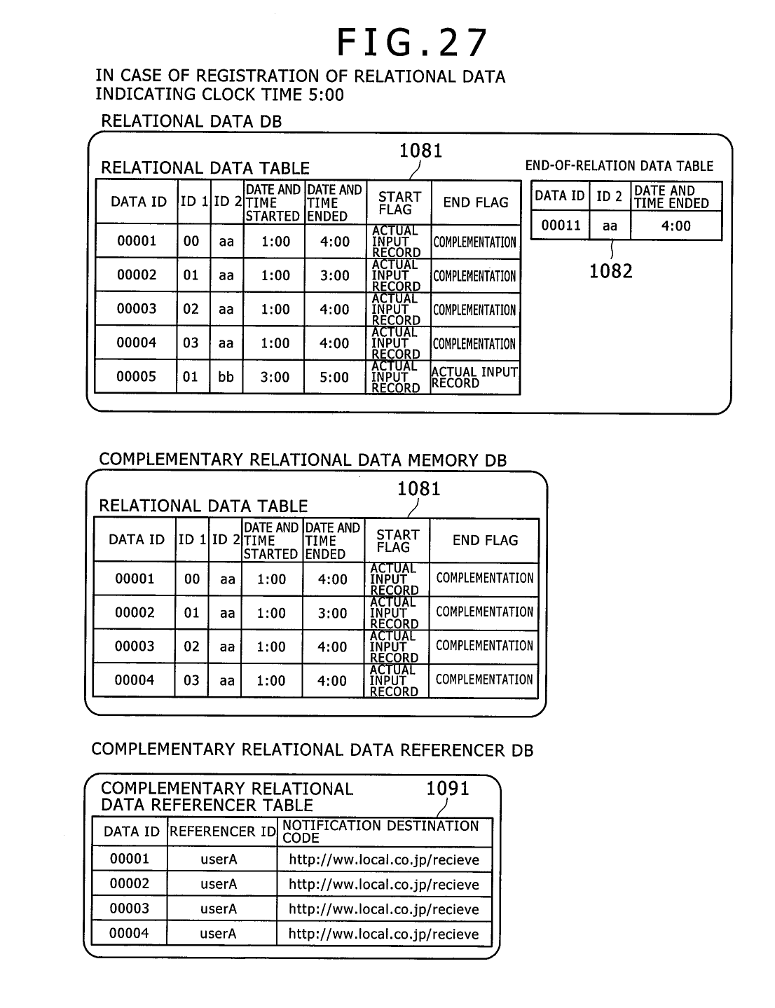

Referring to FIG. 27, there is shown an example of registration of end-of-relation data indicating clock time 5:00. As “Actual input record”, a time value “5:00” is entered in the element “Date and time ended” of the relational data of container case bb and product 01 in the relational data table 1081 stored in the relational data DB 108. From the relational data table 1082 stored in the complementary relational data memory DB 107, the relational data of container case bb and product 01 is removed since both the Start flag and End flag are set to “Actual input record”.

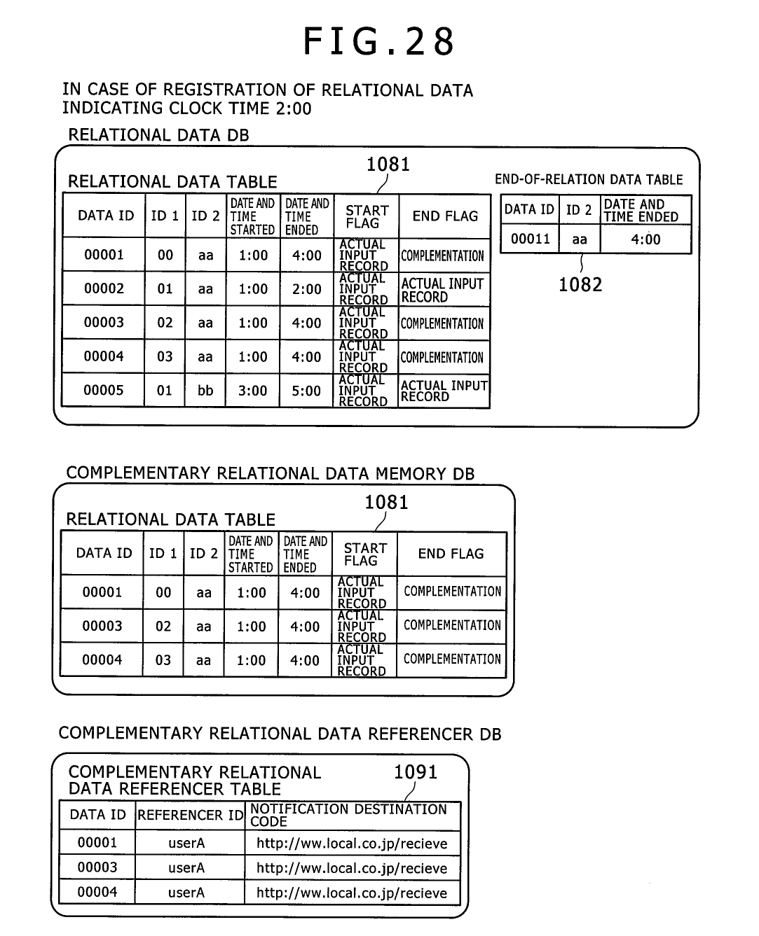

Referring to FIG. 28, there is shown an example of registration of end-of-relation data indicating clock time 2:00. As “Actual input record”, a time value “2:00” is entered in the element “Date and time ended” of the relational data of container case aa and product 01 in the relational data table 1081 stored in the relational data DB 108. From the relational data table 1082 stored in the complementary relational data memory DB 107, the relational data of container case aa and product 01 is removed since both the Start flag and End flag are set to “Actual input record”. Upon updating of the relational data of container case aa and product 01, the updated relational data is sent to a notification destination registered in the complementary relational data referencer table 1091. Further, since the relational data (Data ID 00002 in this example) has been removed from the relational data table 1081 stored in the complement relational data memory DB 107 because of “Actual input record” setting in both the Start flag and End flag, the relevant record corresponding to the relational data (record of Data ID 00002) is also removed from the complementary relational data referencer table 1091.

While the present invention has been described in detail with respect to one of the preferred embodiments thereof, it is to be understood that the present invention is not limited by any of the details of description give herein and that various changes and modification may be made in the present invention without departing from the spirit and scope thereof. For example, the following embodiments may also be provided according to the present invention:

(1) Whereas the complementary relational data memory DB 107 shown in FIG. 1 is stoired in a semiconductor memory device according to the preferred embodiment mentioned above, any other type of memory device such as a hard disk storage device may be used for this purpose.

(2) Whereas information of each referencer (user) to complementary relational data is stored in a memory device and update information regarding the complementary relational data is automatically returned to the referencer according to the preferred embodiment mentioned above, there may be provided such a modified arrangement that the update information regarding the complementary relational data is returned to each referencer in combination with the result of search at the time of user/system-controlled operation for referencing relational data.

(3) Whereas there is provided a method in which relational data indicating that both the Start flag and End flag are set to “Actual input record” is removed from the complementary relational data memory DB 107 at the time of relational data updating, there may also be provided such a modified method that relevant relational data is removed from the complementary relational data memory DB 107 periodically on a batch-processing basis.

It should be understood by those skilled in the art that various modifications, combinations, sub-combinations and alterations may occur depending on design requirements and other factors insofar as they are within the scope of the appended claims or the equivalents thereof.

What is claimed is:

1. A configuration information complementing traceability system for complementing configuration information indicating states of physical distribution of individual articles, comprising:
an input acceptance section for accepting article identification information for identifying each article in a predetermined stage of the physical distribution, container identification information for identifying each container for containing the article, and relational data indicating a correspondence relationship including temporal element information regarding the article identification information and the container identification information;
a storage section for storing the article identification information and the container identification information accepted by the input acceptance section as configuration information associated with the relational data; and
a complementer section for judging whether any necessary data is absent in the configuration information to be stored into the storage section in accordance with the relational data, and for complementing the configuration information by using the relational data if the absence of any necessary data is recognized in the result of judgment on the configuration information.

2. The configuration information complementing traceability system according to claim 1,
wherein the configuration information to be complemented contains relational data, and
wherein the temporal element information in the relational data includes a start date and time of a correspondence relationship between the article identification information and the container identification information, an end date and time of the correspondence relationship between the article identification information and the container identification information, and complementary identification information for indicating whether the temporal element information in the relational data has been stored through complementation by the complementer section or recorded by the acceptance section.

3. The configuration information complementing traceability system according to claim 2, further comprising:
a register section for registering relational data accepted by the input acceptance section into a first storage device included in the storage section in accordance with the complementary identification information, and for registering the relational data complemented into a second storage device included in the storage section.

4. The configuration information complementing traceability system according to claim 3, further comprising:
a request acceptance section for accepting a search request for the configuration information stored in the storage section; and
a judgment section for judging whether to perform a search in the first storage device, the second storage device, or the first and second storage devices in response to the search request accepted.

5. The configuration information complementing traceability system according to claim 3,
wherein the storage section further comprises a third storage device for storing system identification information for identifying a system that has referenced the relational data complemented in case of updating of the relational data complemented, and
wherein a notification section is further provided for acquiring the system identification information stored in the third storage device and for providing notification of updated contents of the relational data.

6. A configuration information complementing method for complementing configuration information indicating states of physical distribution of individual articles in a configuration information complementing traceability system, comprising the steps of:
accepting input of article identification information for identifying each article in a predetermined stage of the physical distribution, container identification information for identifying each container for containing the article, and relational data indicating a correspondence relationship including temporal element information regarding the article identification information and the container identification information;
storing the article identification information and the container identification information accepted into a storage section as configuration information associated with the relational data;
judging whether any necessary data is absent in the configuration information to be stored into the storage section in accordance with the relational data; and
complementing the configuration information by using the relational data if the absence of any necessary data is recognized in the result of judgment on the configuration information.

7. The configuration information complementing method according to claim 6,
wherein the configuration information to be complemented contains relational data, and
wherein the temporal element information in the relational data includes a start date and time of a corresponding relationship between the article identification information and the container identification information, an end date and time of the correspondence relationship between the article identification information and the container information, and complementary identification information for indicating whether the temporal element information in the relational data has been stored through complementation in the step of complementing the configuration information or recoded in the step of accepting input.

8. The configuration information complementing method according to claim 7, further comprising the steps of:
registering relational data accepted in the step of accepting input into a first storage device included in the storage section in accordance with the complementary identification information; and
registering the relational data complemented into a second storage device included in the storage section.

9. The configuration information complementing method according to claim 8, further comprising the steps of:
accepting a search request for the configuration information stored in the storage section; and
judging whether to perform a search in the first storage device, the second storage device, or the first and second storage devices in response to the search request accepted.

10. The configuration information complementing method according to claim 9,
wherein the storage section comprises a third storage device for storing system identification information for identifying a system that has referenced the relational data complemented in case of updating of the relational data complemented, the configuration information complementing method further comprising the steps of:
acquiring the system identification information stored in the third storage device; and
providing notification of updated contents of the relational data.
